(19) United States
(12) Patent Application Publication
(10) Pub. No.: US 2020/0272514 A1
(43) Pub. Date: Aug. 27, 2020

(54) INFORMATION PROCESSING TERMINAL, NON-TRANSITORY RECORDING MEDIUM, AND CONTROL METHOD

(71) Applicant: YASUHIRO HAYASHI, KANAGAWA (JP)

(72) Inventor: YASUHIRO HAYASHI, KANAGAWA (JP)

(73) Assignee: Ricoh Company, Ltd., Tokyo (JP)

(21) Appl. No.: 16/783,352

(22) Filed: Feb. 6, 2020

(30) Foreign Application Priority Data
Feb. 27, 2019 (JP) 2019-034049

(51) Int. Cl. G06F 9/48; G06Q 10/10; G06Q 10/02; G06F 3/0488

(52) U.S. Cl. CPC G06F 9/4881; G06Q 10/1095; G06F 3/04883; G06Q 10/107; G06Q 10/02

(57) ABSTRACT

An information processing terminal includes a display and a memory that stores a plurality of control target applications. When a status of a first control target application of the plurality of control target applications is changed, the information processing terminal switches a control target application to be displayed on a frontmost screen of the display in accordance with a change in the status of the first control target application.

### CROSS-REFERENCE TO RELATED APPLICATIONS

This patent application is based on and claims priority pursuant to 35 U.S.C. § 119(a) to Japanese Patent Application No. 2019-034049, filed on Feb. 27, 2019, in the Japan Patent Office, the entire disclosure of which is hereby incorporated by reference herein.

### BACKGROUND

### Technical Field

The present disclosure relates to an information processing terminal, a non-transitory recording medium, and a control method.

### Description of the Related Art

Software of a plurality of applications can operate on a single information processing terminal. Since the information processing terminal has a single display, a user typically displays, on the display, application software that the user operates. In addition, a technique is known for automatically starting application software and displaying the started application software.

### SUMMARY

According to one or more embodiments, an information processing terminal includes a display and a memory that stores a plurality of control target applications. When a status of a first control target application of the plurality of control target applications is changed, the information processing terminal switches a control target application to be displayed on a frontmost screen of the display in accordance with a change in the status of the first control target application.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is an example illustrating an outline of the entire operation of a resource reservation system, according to an embodiment of the present disclosure;

FIG. 2 is an example illustrating a schematic configuration and communication partners of a meeting-room terminal, according to an embodiment of the present disclosure;

FIG. 3 is an example illustrating an outline of operations of the meeting-room terminal, according to an embodiment of the present disclosure;

FIG. 4 illustrates a system configuration example of the resource reservation system, according to an embodiment of the present disclosure;

FIG. 5 illustrates a hardware configuration example of a meeting management server, according to an embodiment of the present disclosure;

FIG. 6 illustrates a hardware configuration example of the meeting-room terminal, according to an embodiment of the present disclosure;

FIG. 7 is a block diagram illustrating an example of functional configurations of a reservation management server, a chat server, the meeting management server, and a registration terminal, according to an embodiment of the present disclosure;

FIG. 8A and FIG. 8B are block diagrams illustrating an example of functional configurations of a terminal apparatus, the meeting-room terminal, and a management apparatus, according to an embodiment of the present disclosure;

FIG. 9 is a block diagram illustrating an example of functional configurations of in-terminal communication units, according to an embodiment of the present disclosure;

FIG. 10 illustrates a screen transition example of the meeting-room terminal, according to an embodiment of the present disclosure;

FIG. 11 is a sequence diagram example illustrating a procedure in which a control application displays a control target application on a frontmost screen, according to an embodiment of the present disclosure;

FIG. 12 is a sequence diagram example illustrating a procedure in which a control application installed in the meeting-room terminal registers, in a management apparatus, an application installed in the meeting-room terminal, according to an embodiment of the present disclosure;

FIG. 13 is a sequence diagram example illustrating a procedure in which an administrator or the like changes degrees of priority held by the control application to display a control target application on the frontmost screen, according to an embodiment of the present disclosure;

FIG. 14 illustrates an example of a remote setting screen that displays search results of meeting-room terminals, according to an embodiment of the present disclosure; and

FIG. 15 illustrates another example of the remote setting screen that displays search results of meeting-room terminals, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Now, as examples for implementing the present disclosure, a meeting-room terminal (example of information processing terminal) and a control method performed by the meeting-room terminal will be described with reference to the drawings.

### Outline of Resource Reservation System

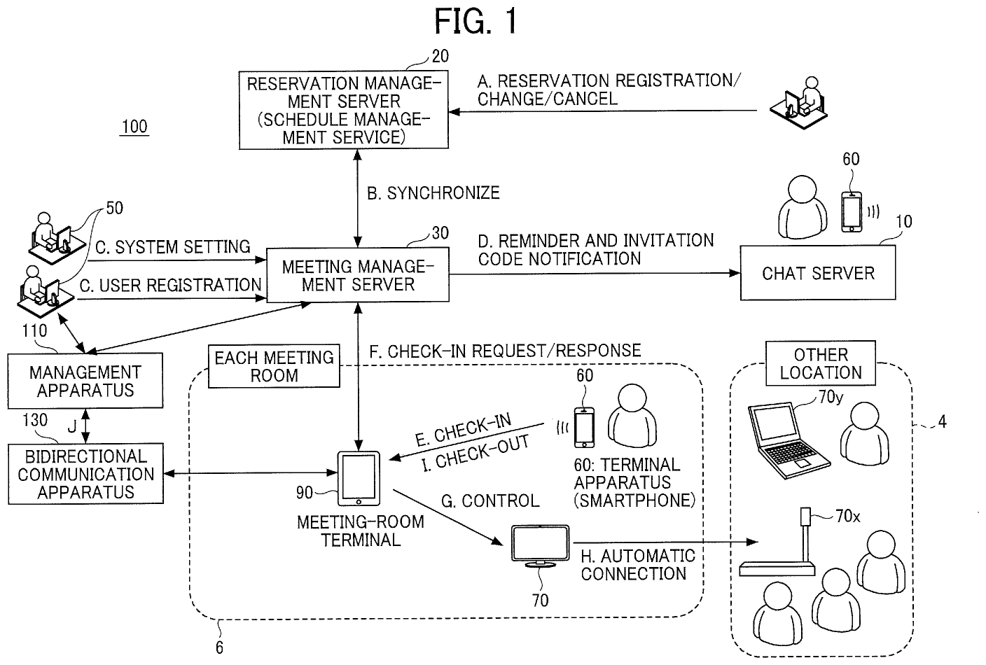

First, an outline of a resource reservation system will be described with reference to FIG. 1. FIG. 1 is an example illustrating an outline of the entire operation of a resource reservation system 100.

A. By operating his/her terminal apparatus 60, a reserving person communicates with a reservation management server 20 and reserves a meeting room. The reservation management server 20 is a general-purpose cloud service (e.g., Office 365, G Suite (both are registered trademarks), or the like) in which meeting rooms are registered. The meeting rooms are owned by an organization such as a company to which the reserving person belongs.

B. On the basis of a meeting-room reservation status, a meeting management server 30 controls the entirety of the resource reservation system 100. The meeting management server 30 obtains reservation information by communicating with the reservation management server 20 as appropriate. Thus, the reservation information is synchronized between the reservation management server 20 and the meeting management server 30.

C. An administrator, for example, in the organization that uses the resource reservation system 100 can register users and set various settings in the meeting management server 30. To register a user is to register, in the meeting management server 30, identification (ID), an email address, or the like for identifying the individual user of the resource reservation system 100. For example, a user to whom various notifications are to be sent by using a chat server 10 (e.g., slack, LINE, Microsoft Teams (all of them are registered trademarks), or the like) is registered. In addition, since a notification is sent from a bot that transmits a message as the meeting management server 30, a bot provided by the chat server is also registered. The bot is a program for providing, to a user, an interface of various notifications, acceptance of inputs, and the like as an agent of the resource reservation system 100 or the meeting management server 30 in each chat application (terminal application of a chat system) in a terminal, such as a smartphone, owned by each user. The bot is a program on the chat server 10 and sends notifications, accepts inputs, provides various kinds of guidance, and the like while communicating with a user (user of the resource reservation system 100) as a virtual chat partner. As an example, the bot serves as a contact of the system by, for example, sending a reminder of the reservation information to the user from the resource reservation system 100 or by receiving, in a chat, user input for participating or not participating in a meeting as a response to the reminder. The various settings are registration of a meeting-room terminal 90, setting of a reminding time, and the like.

D. At a certain time before a meeting start time according to the reservation information, the meeting management server 30 sends a reminder of the scheduled meeting to the reserving person, thereby reducing an empty reservation of a meeting room. The “empty reservation” refers to that a user reserves resources such as a meeting room, but the user does not actually use the reserved resource without cancelling. In addition, the meeting management server 30 notifies the user of an invitation code (invitation to a group) as necessary. By receiving the reminder, the reserving person of the meeting stores information for checking in the meeting room (meeting identification information) in the terminal apparatus 60. To check in is processing in which the user inputs an instruction for check-in to start to use the meeting room, the meeting management server 30 receives, in response to the instruction for check-in, information indicating check-in and sets a start flag indicating the start of use of the predetermined meeting room.

E. The meeting-room terminal 90 is provided in each meeting room 6 and regularly downloads reservation information of a meeting to be held in the meeting room 6. The meeting-room terminal 90 can display schedules of meetings of the day or upcoming meetings so that participants of the meetings can view the schedules. At a time slightly before the meeting start time, the reserving person of the meeting room 6 comes to the meeting room 6 and checks in. For example, the reserving person inputs the meeting identification information to the meeting-room terminal 90 or places the terminal apparatus 60 over the meeting-room terminal 90 (e.g., the meeting identification information is read, communication is performed, or the user presses a check-in button (use start button) displayed by a terminal application 90a of the meeting-room terminal 90).

F. The meeting-room terminal 90 transmits a check-in request to the meeting management server 30, and thus, if authentication succeeds on the basis of the meeting identification information, receives a response indicating successful check-in from the meeting management server 30. Display on the meeting-room terminal 90 indicates “during use” (during meeting). If no use start notification indicating check-in is received by a predetermined time before the meeting start time, the meeting management server 30 cancels reservation of the meeting room 6 (deletes the reservation information if use of the meeting room does not start for a predetermined period of time) and transmits reservation information indicating “canceled” as a status to the meeting-room terminal 90. In this case, display on the meeting-room terminal 90 indicates “vacant”, and thus, a given user can use the meeting room 6.

G. The meeting-room terminal 90 controls an electronic device 70 in response to a request from the meeting management server 30. For example, the meeting-room terminal 90 turns on the electronic device 70 at the meeting start time and turns off the electronic device 70 at a meeting end time. This can increase the usability of the electronic device 70 for participants of the meeting.

H. In a case where the electronic device 70 has a function for teleconference, for example, the electronic device 70 can communicate with an electronic device (e.g., a teleconference terminal 70x) at another location 4 to hold a meeting with the other location. Note that a PC 70y on which an application operates can also communicate with the electronic device 70. The reservation information includes in advance address information (communication ID of a destination) indicating the other location 4, and the electronic device 70 can automatically communicate with the teleconference terminal 70x and the PC 70y.

I. When the meeting ends, the reserving person presses a button of the meeting-room terminal 90 for check-out, and the meeting-room terminal 90 displays the next reservation status. This enables a given user to understand the reservation status of the meeting room 6.

J. In addition, a management apparatus 110 and a bidirectional communication apparatus 130 are provided on a network. The management apparatus 110 is connected so as to be able to communicate with the meeting-room terminal 90 through the bidirectional communication apparatus 130. The bidirectional communication apparatus 130 is a communication apparatus that relays communication from the management apparatus 110 to the meeting-room terminal 90 and relays communication from the meeting-room terminal 90 to the management apparatus 110. An administrator can establish a connection from a registration terminal 50 to the management apparatus 110, receive various settings from the meeting-room terminal 90, and transmit various settings to the meeting-room terminal 90. In addition, the management apparatus 110 is also connected so as to be able to communicate with the meeting management server 30 and can establish a connection from the meeting management server 30 to the meeting-room terminal 90.

### Outline of Operations

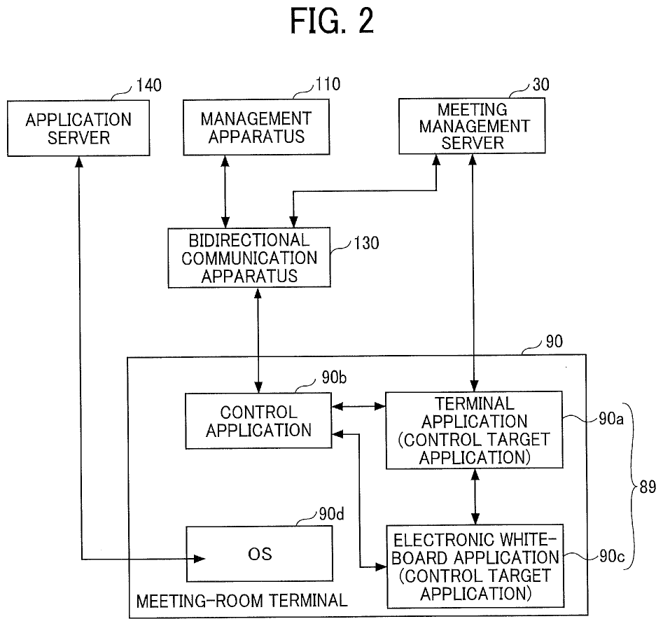

FIG. 2 is an example illustrating a schematic configuration and communication partners of the meeting-room terminal 90. In the meeting-room terminal 90, a control application 90b and a plurality of control target applications 89 are installed. The control application 90b and control target applications 89 are each simply referred to as an application (abbreviation for application software) unless they are not distinguished from each other. Although being provided within a firewall, the meeting-room terminal 90 can receive communication from the management apparatus 110 or the meeting management server 30 through the bidirectional communication apparatus 130. Each of the applications of the meeting-room terminal 90 within the firewall can spontaneously communicate with the meeting management server 30 or the like, and an operating system (OS) 90d can spontaneously communicate with an application server 140 on the cloud.

The OS 90d communicates with the application server 140 and if a new-version application of an application installed in the meeting-room terminal 90 is prepared, the OS 90d downloads the application and updates the old-version application. Note that the application needs to be stopped when updated.

The control application 90b controls operations of the control target applications 89, and the control target applications 89, although being different according to the function, have functions of receiving control-related notifications by communicating with the control application 90b. In FIG. 2, the control target applications 89 are the terminal application 90a and an electronic whiteboard application 90c. Since the terminal application 90a displays a standby screen that accepts check-in, the terminal application 90a is to be displayed on the frontmost screen before a meeting starts. Since the electronic whiteboard application 90c is used during a meeting, the electronic whiteboard application 90c is to be displayed on the frontmost screen after the meeting has started.

The control application 90b can accept setting from the management apparatus 110 through the bidirectional communication apparatus 130. For example, the control application 90b can accept change in degrees of priority of the control target applications 89. In addition, the control application 90b can accept setting from the management apparatus 110 concerning, for example, when to stop or start the control target applications 89.

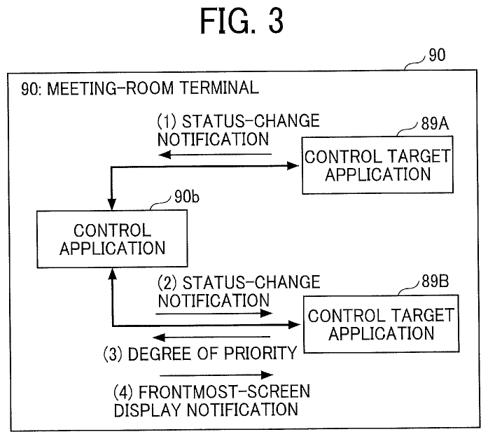

FIG. 3 is an example illustrating an outline of operations of the meeting-room terminal 90 according to this embodiment. In this embodiment, in the meeting-room terminal 90, the control application 90b and the one or more control target applications 89 are installed.

Main functions of the control application 90b are as follows.
function of receiving, from each of the control target applications 89, the degree of priority managed by the corresponding control target application 89
function of receiving a status-change notification from a control target application 89 for which the status is changed
function of sending the status-change notification to other control target applications 89
function of determining which control target application 89 is to be displayed on the frontmost screen on the meeting-room terminal 90
function of transmitting a frontmost-screen display notification to an application that is to be displayed on the frontmost screen
function of transmitting a stop notification to an application that is not to be displayed on the frontmost screen

Functions of each of the control target applications 89 are as follows.
function of sending a status-change notification to the control application 90b if the status is changed
function of displaying a screen generated by the control target application 89 on the frontmost screen

Now, description will be given with reference to FIG. 3. In the following description, different control target applications 89 are distinguished from one another by adding alphabetical letters A to C to the reference numeral, and a given control target application among them is a control target application 89.
(1) In a state where a screen of a control target application 89A (example of first control target application, acceptance application) is the frontmost screen, the control target application 89A for which the status is changed sends a status-change notification to the control application 90b.
(2) The control application 90b sends the status-change notification to a control target application 89B (example of second control target application).
(3) In accordance with the status-change notification, if necessary, the control target application 89B changes the degree of priority and notifies the control application 90b of the changed degree of priority.
(4) On the basis of the degree of priority, the control application 90b determines the control target application to be displayed on the frontmost screen and, in FIG. 2, sends a frontmost-screen display notification to the control target application 89B.

In the above manner, in accordance with the status of each of the control target applications 89, the control application 90b sends the frontmost-screen display notification, thereby controlling which control target application is to be displayed on the frontmost screen.

### Terminology

The term “resource” refers to a resource such as a meeting room, and equipment, device, person (receptionist), mechanisms, etc. that can be used in the meeting room. Among resources, a resource that is difficult to move is referred to as a “facility”. In this embodiment, the term “meeting room” is used as an example of the resource for the convenience of the description.

The control target application refers to an application that controls the control target application under control of the control application 90b. The control target application may also be controlled by the control application 90b through a function of the OS. The control target application may have any function.

The control application 90b refers to an application that controls operations of the control target application. The control application 90b may have a certain function for displaying a standby screen or for accepting input of hand-written information.

### System Configuration Example

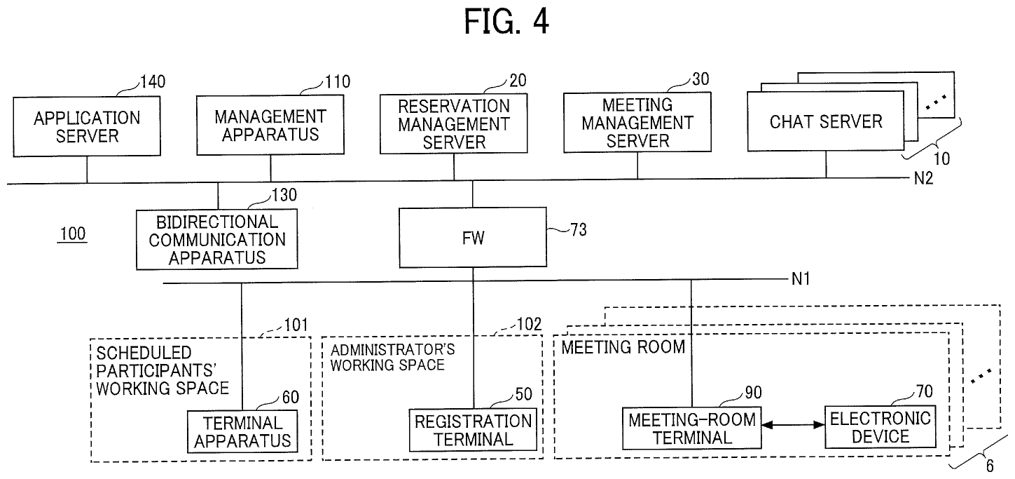

FIG. 4 illustrates a system configuration example of the resource reservation system 100. The resource reservation system 100 can be mainly divided into an in-house network N1 and an outside network N2. The in-house network N1 is a network inside a firewall 73 (on-premises), and the outside network N2 is a network such as the Internet via which an unspecified large number of communications are performed.

To the outside network N2, the reservation management server 20, the meeting management server 30, the at least one chat server 10, and the bidirectional communication apparatus 130 that communicates with the management apparatus 110 are connected, and each of the servers can perform communication as necessary. To the outside network N2, the terminal apparatus 60 operated by a participant of a meeting may be connected as necessary.

The reservation management server 20 is implemented by one or more information processing apparatuses (computer system) in which a typical server OS or the like is installed. A system related to reservation of equipment provided by the reservation management server 20 is referred to as a reservation management system. The reservation management server 20 has a calendar system and provides a web application that manages various kinds of schedules. Specifically, for example, the reservation management server 20 has the following functions:
to accept registration of a schedule and allow the reserving person to view the schedule at any time;
to remind the schedule by email at a set date and time, e.g., half an hour before the schedule;
to allow a person to manage the schedule by using a plurality of calendars (for work, for home, and the like); and
to allow persons in the same group to share a calendar.

The reservation management server 20 manages users by using accounts. An account is a right for a user to use a service. In many systems, the user logs in to a system by using the account. Thus, the account has a function for the system to uniquely identify the user (function of identification information). In this embodiment, the reservation management server 20 transmits, to the meeting management server 30, reservation information of an account (domain) registered in advance. Alternatively, by designating the account used by the reservation management server 20, the meeting management server 30 requests the reservation information, and the meeting management server 30 can obtain the reservation information of the meeting room 6 from the reservation management server 20. Note that the account may be any information by which the user can be uniquely identified, such as an email address, ID, or a telephone number.

Although the reservation of the meeting room 6 is managed as a schedule in this embodiment, the reservation management server 20 can manage various kinds of schedules in addition to the meeting room 6. In addition to the meeting room 6, the reservation management server 20 can be used for renting any kind of electronic device, reserving a parking lot, and reserving various kinds of equipment, such as a rental office, a rental studio, a rental cycle, a rental car, an accommodate such as a hotel, a rental space such as a hall for entertainment or a locker.

Note that as the reservation management server 20 or the reservation management system including a reservation management server, G Suite (registered trademark), Office 365 (registered trademark), and the like are known. However, any reservation management system having the functions described in this embodiment may be used.

In addition, in this embodiment, information regarding the meeting room 6 in the in-house network N1 is registered in advance in the reservation management server 20. That is, the web application of the reservation management server 20 is customized in accordance with the meeting-room name, the meeting-room ID, an available time, a capacity, a reservation unit, and the like of each meeting room 6 in the in-house network of a company that uses the resource reservation system 100. Thus, the meeting room 6 of the company that uses the resource reservation system 100 and the reservation information are coupled to each other.

The chat server 10 can be implemented by one or more information processing apparatuses (computer system) in which a typical server OS or the like is installed. A system provided by the chat server 10 for sharing information such as text, sound, or video in real time among a plurality of users is referred to as a chat system. The chat server 10 notifies the terminal apparatus 60 of information regarding reservation of the meeting room 6. In this embodiment, a plurality of chat servers 10 whose operating units are different may be included.

The shared information is not limited to text and may be images, sound, and the like. However, for the convenience of the description, this embodiment will describe text being mainly used for notification. For example, the chat system may provide a function for voice communication within a group. The voice communication may be performed one on one or one on N (≥2). Thus, in this embodiment, in a case where the chat system notifies the terminal apparatus 60 of information regarding reservation of the meeting room 6, the chat system may display text or may output a voice message. Note that although LINE (registered trademark, hereinafter omitted), slack (registered trademark, hereinafter omitted), Microsoft Teams (registered trademark, hereinafter omitted), and the like are known as the chat system, any chat system that can notify one or more users by using a bot (program for executing predetermined processing) may be used.

Although the chat server 10 similarly manages users by using accounts (different from the accounts used by the reservation management server 20), in principle, it is unnecessary for the meeting management server 30 to be aware of the accounts used by the chat server 10. However, the meeting management server 30 can designate a given account used by the chat server 10 for notification.

The meeting management server 30 can be implemented by one or more information processing apparatuses (computer system) in which a typical server OS or the like is installed. As processing regarding the outside network N2, the meeting management server 30 obtains the reservation information of the meeting room 6 from the reservation management server 20, obtains scheduled participants that are set in the reservation information, and notifies a group (or an individual person such as a reserving person) of the chat server 10 associated with the scheduled participants at a set time. In addition, as processing regarding the in-house network N1, the meeting management server 30 manages check-in and check-out of the meeting room 6 and controls a power or the like of the electronic device 70 on the basis of the reservation information of the meeting room 6 obtained from the reservation management server 20.

The management apparatus 110 is an information processing apparatus that provides the registration terminal 50 with a web application for accepting various settings of the meeting-room terminal 90 from an administrator. As a so-called web server, the management apparatus 110 generates screen information for accepting various settings of the meeting-room terminal 90 and transmits the screen information to the registration terminal 50.

The bidirectional communication apparatus 130 is an information processing apparatus that provides a bidirectional communication service between an information processing apparatus on the cloud and an information processing apparatus within a firewall (on-premises information processing apparatus). By the bidirectional communication apparatus 130, the management apparatus 110 or the meeting management server 30 can communicate with the meeting-room terminal 90 within the firewall. Note that although Azure IoT Hub (registered trademark) is known as an example of the bidirectional communication apparatus 130, the bidirectional communication apparatus 130 may be any other apparatus.

The in-house network N1 includes the meeting room 6, a scheduled participants' working space 101, an administrator's working space 102, and the like, and the scheduled participants can access the outside network N2 via the in-house network N1 from the respective locations. For example, the in-house network N1 is a local area network (LAN). The meeting room 6, the scheduled participants' working space 101, and the administrator's working space 102 are not necessarily within the LAN of the same company.

In the meeting room 6, the meeting-room terminal 90 and the electronic device 70 are provided. The meeting-room terminal 90 and the electronic device 70 can perform communication via a small-scale LAN or a dedicated line. The electronic device 70 can be connected to the in-house network N1 and the outside network N2 without via the meeting-room terminal 90. The meeting-room terminal 90 and the electronic device 70 may perform wireless or wired communication. Note that the in-house network N1 is within the firewall 73, and thus, direct communication from the outside network N2 to the in-house network N1 is difficult.

The meeting-room terminal 90 is an information processing terminal operated by a participant of a meeting, such as a reserving person who uses the meeting room 6. The meeting-room terminal 90 may be provided on a desk in the meeting room 6 or at the entrance of the meeting room 6. A plurality of meeting-room terminals 90 may be provided in the meeting room 6. The meeting-room terminal 90 can be implemented by one or more information processing apparatuses (computer system) in which a typical OS or the like is installed.

The meeting-room terminal 90 transmits the meeting-room ID to the meeting management server 30 and displays the reservation information of the meeting room 6 of the day, for example. In addition, the meeting-room terminal 90 regularly requests the reservation information and obtains changed reservation information. Furthermore, the meeting-room terminal 90 obtains control information for turning on or off the electronic device 70, for example, from the meeting management server 30. Thus, the meeting-room terminal 90 turns on or off the electronic device 70.

In addition, the meeting-room terminal 90 displays a standby screen for check-in, check-out, and the like, and communicates with the meeting management server 30 in order to notify the meeting management server 30 of check-in or check-out. At the time of check-in, the meeting-room terminal 90 transmits, to the meeting management server 30, the meeting identification information that is input by the reserving person and the meeting-room ID that is held in advance, and thus, from the meeting identification information and the meeting-room ID, the meeting management server 30 can confirm that the meeting room 6 that is reserved by the reserving person, who has reserved the meeting room 6, is to be used.

The electronic device 70 is any of various kinds of office devices that can be used in the meeting room 6. For example, the electronic device 70 is an electronic whiteboard, a multi-function device, a projector, a digital signage, a digital camera, or the like. The electronic whiteboard includes a large display with a touch panel, detects coordinates on a board designated by a user and connects the coordinates to display a stroke. In addition, the electronic whiteboard can display a video in a personal computer (PC) connected thereto or perform communication with an electronic whiteboard at another location to synchronize strokes. Note that the electronic whiteboard may also be referred to as an electronic information board or an interactive whiteboard.

The multi-function device includes functions of a copier, a scanner, a printer, and a facsimile and is used to print or copy a material used during a meeting, digitize a material, transmit a material, or the like. The projector is an apparatus that projects an image. For example, a video displayed by the terminal apparatus 60 on a display can be projected onto a screen or the like to be shared among participants. The digital signage is a large-scale display and is used to display a given still image or moving image. The digital camera is used by each participant to capture an image of a paper material or a material displayed on the electronic whiteboard and store the image.

In the scheduled participants' working space 101, the terminal apparatus 60 that can be connected to the in-house network N1 is provided. The terminal apparatus 60 may perform wireless or wired communication. The terminal apparatus 60 is an information processing apparatus used when a scheduled participant (including the reserving person) reserves a meeting room and is assumed to be carried into the meeting room. The terminal apparatus 60 is an information processing apparatus carried by a scheduled participant.

The terminal apparatus 60 can be implemented by one or more information processing apparatuses (computer system) in which a typical OS or the like is installed. The terminal apparatus 60 is, for example, a smartphone, a tablet terminal, a PC, a personal digital assistant (PDA), a wearable PC (e.g., sunglasses type or wristwatch type), or the like. Note that the terminal apparatus 60 may be any apparatus that has a communication function and on which browser software or application software dedicated to the chat server 10 or the reservation management server 20 operates. For example, the terminal apparatus 60 may be a car navigation device, a game console, a television receiver, or the like.

On the terminal apparatus 60, application software dedicated to the chat server 10 (hereinafter referred to as a chat application) operates, and further, application software dedicated to the resource reservation system 100 (hereinafter referred to as a meeting application) operates. However, these may be substituted by browser software.

In the administrator's working space 102, the registration terminal 50 that can be connected to the in-house network N1 is provided. The registration terminal 50 may perform wireless or wired communication. The registration terminal 50 is a terminal used by the administrator to set various settings in the meeting management server 30.

The registration terminal 50 may be an information processing apparatus that is the same as or substantially the same as the terminal apparatus 60. However, mainly, the registration terminal 50 is used by the administrator to set the meeting management server 30, the registration terminal 50 does not necessarily include the chat application or the meeting application. The registration terminal 50 mainly communicates with the meeting management server 30 by browser software to display a web page.

### Hardware Configuration

### Meeting Management Server

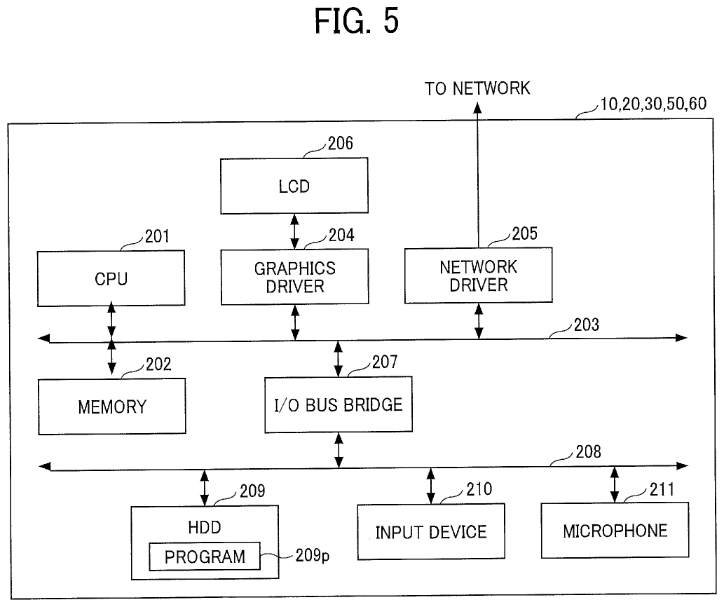

FIG. 5 illustrates a hardware configuration example of the meeting management server 30. This is an example of a schematic hardware configuration of the meeting management server 30. The meeting management server 30 includes a central processing unit (CPU) 201 and a memory 202 that enables high-speed access to data used by the CPU 201. The CPU 201 and the memory 202 are connected to other devices or drivers of the meeting management server 30, such as a graphics driver 204 and a network driver (NIC) 205, via a system bus 203.

The graphics driver 204 is connected to a liquid crystal display (LCD, an example of a display) 206 via a bus to monitor processing results of the CPU 201. In addition, the network driver 205 connects the meeting management server 30 to the outside network N2 in the transport layer level or in the physical layer level to establish a session with another device.

To the system bus 203, further, an input/output (I/O) bus bridge 207 is connected. In the downstream of the I/O bus bridge 207, a storage device such as a hard disk drive (HDD) 209 is connected via an I/O bus 208 such as a peripheral component interconnect (PCI) by Integrated Drive Electronics (IDE), Advanced Technology Attachment (ATA), ATA Packet Interface (ATAPI) 801, serial ATA, Small Computer System Interface (SCSI), Universal Serial Bus (USB), or the like. The HDD 209 stores a program 209p that controls the entirety of the meeting management server 30. The HDD 209 may be a solid state drive (SSD). The program 209p may be distributed by being stored in a storage medium or may be distributed from a server for program distribution.

In addition, to the I/O bus 208, an input device 210 such as a keyboard and a mouse (also referred to as a pointing device), as well as a microphone 211, are connected via a bus such as a USB. The input device 210 accepts an input and instruction by an operator such as a system administrator.

Note that the illustrated hardware configuration of the meeting management server 30 illustrates hardware components that are preferably included in the meeting management server 30.

The hardware configuration of each of the reservation management server 20, the chat server 10, the registration terminal 50, and the terminal apparatus 60 is the same or substantially the same as that of the meeting management server 30. Even if the hardware configuration of each of the reservation management server 20, the chat server 10, the registration terminal 50, and the terminal apparatus 60 is different from that of the meeting management server 30, no problem arises in the description of the resource reservation system 100 according to this embodiment. In addition, in order to support cloud computing, the hardware configuration of the meeting management server 30, the reservation management server 20, and the chat server 10 may be made by dynamically connecting/cutting a hardware resource in accordance with a load. Note that cloud computing is a use form of resources on a network without awareness of a specific hardware resource.

### Meeting-Room Terminal

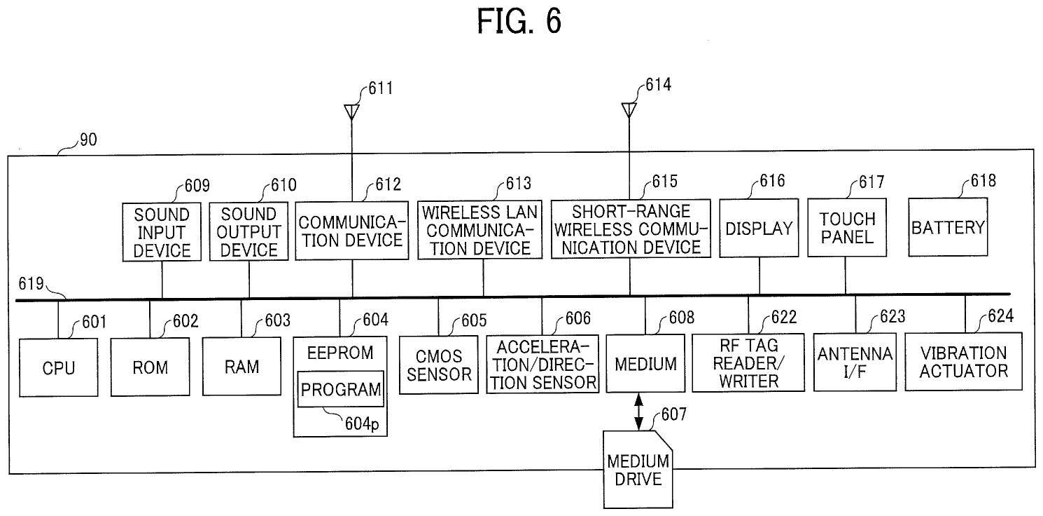

FIG. 6 illustrates a hardware configuration example of the meeting-room terminal 90. Note that the meeting-room terminal 90 in FIG. 6 is assumed to be a tablet apparatus. The meeting-room terminal 90 includes a CPU 601, a read-only memory (ROM) 602, a random access memory (RAM) 603, an electrically erasable programmable read-only memory (EEPROM) 604, a complementary metal-oxide-semiconductor (CMOS) sensor 605, an acceleration/direction sensor 606, and a medium drive 608.

The CPU 601 controls the entire operation of the meeting-room terminal 90. The ROM 602 stores a basic input/output program. The RAM 603 is used as a work area of the CPU 601. The EEPROM 604 reads or writes data under control of the CPU 601. The CMOS sensor 605 images a subject under control of the CPU 601 and obtains image data. The acceleration/direction sensor 606 is an electro-magnetic compass, which detects a geomagnetism, a gyrocompass, an acceleration sensor, or the like.

The medium drive 608 controls reading or writing (storing) of data from or to a medium 607 such as a flash memory. The medium drive 608 is configured such that the medium 607 can be detachably attached. Data that is already recorded is read from the medium 607, or data is newly written and stored in the medium 607.

Note that the EEPROM 604 stores a program 604p to be executed by the CPU 601. The program 604p is application software, an OS, or the like for performing various kinds of processing in the embodiment. The program 604p may be distributed by being stored in the medium 607 or the like or may be distributed from a server for program distribution.

In addition, the CMOS sensor 605 is a charge coupled device, which converts light into charge to digitize a subject's image. As long as a subject can be imaged, the CMOS sensor 605 may be a charge coupled device (CCD) sensor, for example. The CMOS sensor 605 can read a barcode or a two-dimensional barcode.

The meeting-room terminal 90 further includes a radio-frequency (RF) tag reader/writer 622, an antenna interface (I/F) 623, and a vibration actuator 624. The RF tag reader/writer 622 performs communication in compliance with a standard such as Near-Field Communication (NFC).

The vibration actuator 624 is a motor that vibrates the meeting-room terminal 90. For example, near a meeting end time, the meeting-room terminal 90 vibrates so as to inform participants of that.

The meeting-room terminal 90 further includes a sound input device 609, a sound output device 610, an antenna 611, a communication device 612, a wireless LAN communication device 613, a short-range wireless communication antenna 614, a short-range wireless communication device 615, a display 616, a touch panel 617, and a bus line 619.

The sound input device 609 converts sound into a sound signal. The sound output device 610 converts a sound signal into sound. The communication device 612 communicates with the nearest base station apparatus by a wireless communication signal via the antenna 611. The wireless LAN communication device 613 performs wireless LAN communication in compliance with the IEEE 802.11 standard.

The short-range wireless communication device 615 is a communication device in compliance with, for example, a communication standard of Bluetooth (registered trademark) or Bluetooth Low Energy (registered trademark) via the short-range wireless communication antenna 614.

The display 616 is an LCD, an organic electroluminescent (EL) display, or the like that displays a subject's image, various icons, and the like. The touch panel 617 is placed on the display 616 and constituted by a pressure-sensitive or capacitive panel. The display 616 detects a touch position touched by a finger, a stylus, or the like on the display 616. The bus line 619 is an address bus, a data bus, or the like for electrically connecting the above devices to each other.

The meeting-room terminal 90 further includes a dedicated battery 618 and may be driven by either the battery 618 or a commercial power supply. Note that the sound input device 609 includes a microphone to which sound is input. The sound output device 610 includes a speaker from which sound is output.

### Functions

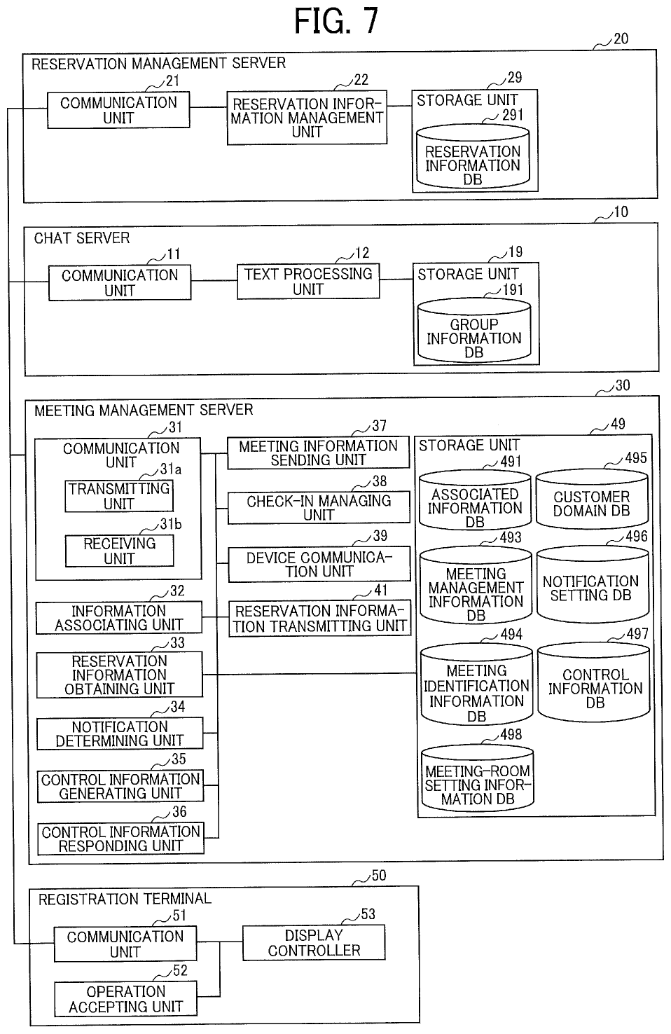

FIG. 7 is a block diagram illustrating an example of functional configurations of the reservation management server 20, the chat server 10, the meeting management server 30, and the registration terminal 50.

### Reservation Management Server

The reservation management server 20 includes a communication unit 21 and a reservation information management unit 22. Each of these functional units included in the reservation management server 20 is a function or means implemented by any of the components illustrated in FIG. 5 being operated in accordance with a command from the CPU 201 executing the program 209p that is loaded from the HDD 209 to the memory 202.

The communication unit 21 transmits/receives various kinds of information to/from the meeting management server 30 and the terminal apparatus 60. The communication unit 21 transmits screen information of a reservation setting screen to the terminal apparatus 60 and receives reservation setting from the terminal apparatus 60. In addition, the communication unit 21 transmits reservation information to the meeting management server 30.

The reservation information management unit 22 is a typical web server (web application) that receives reservation information and further manages reservation information registered by a user. Upon registration (or change) of reservation information, the reservation information management unit 22 notifies the meeting management server 30 of an account of a reserving person, and in accordance with a request designating the account from the meeting management server 30, transmits the reservation information to the meeting management server 30 through the communication unit 21. Even if there is no request, the reservation information management unit 22 may transmit changed reservation information to the meeting management server 30. As a method for the reserving person to reserve the meeting room 6 in the reservation management server 20, a typical web application is used.

The reservation management server 20 includes a storage unit 29. The storage unit 29 is implemented by the memory 202, the HDD 209, and the like in FIG. 5. The storage unit 29 stores a reservation information database (DB) 291.

TABLE 1
Reservation Information DB:

| | Reserving | | | | | Scheduled |
|---|---|---|---|---|---|---|
| Reservation | Person's | Meeting | Meeting- | | | Participants' |
| ID | Account | Name | Room ID | Start Time | End Time | Accounts |
| 001 | a@xfood.com | Product Z | K-001 | 2017/07/07 | 2017/07/07 | b@xfood.com |
| | | Development | | 10:00 | 12:00 | c@xfood.com |
| | | Meeting | | | | d@xfood.com |
| 002 | e@xfood.com | Product Y | K-001 | 2017/07/07 | 2017/07/07 | f@xfood.com |
| | | Development | | 13:00 | 14:00 | g@xfood.com |
| | | Meeting | | | | |
| . . . | . . . | . . . | . . . | . . . | . . . | . . . |

Table 1 illustrates an example of the reservation information stored in the reservation information DB 291. The reservation information is information for managing a reservation status of the meeting room 6. In the reservation information, items that are a reserving person's account, a meeting name, a meeting-room ID, a start time, an end time, and scheduled participants' accounts are registered in association with a reservation ID. The reservation ID is identification information for identifying a single record of the reservation information. The “ID” is an abbreviation of identification and means an identifier or identification information. ID is any one of a name, a symbol, a character string, a numerical value, or a combination of at least two of these items, which is used for identifying a particular object from among a plurality of objects. The reserving person's account is an account of a scheduled participant who has reserved the meeting room 6. The meeting name is a name of a meeting that the scheduled participant has provided as appropriate. The meeting-room ID is identification information for identifying the meeting room 6 within the in-house network. The start time is the start of a period of time for which the meeting room 6 is reserved (time when the meeting starts), and the end time is the end of the period of time for which the meeting room 6 is reserved (time when the meeting ends). The scheduled participants' accounts are accounts of scheduled participants who are scheduled to participate in the meeting. Note that each of the accounts in Table 1 is published by the reservation management server 20.

### Chat Server

The chat server 10 includes a communication unit 11 and a text processing unit 12. Each of these functional units included in the chat server 10 is a function or means implemented by any of the component categories illustrated in FIG. 5 being operated in accordance with a command from the CPU 201 executing the program 209p that is loaded from the HDD 209 to the memory 202.

The communication unit 11 transmits/receives various kinds of information to/from the meeting management server 30. In this embodiment, from the meeting management server 30, the communication unit 11 receives the information regarding reservation of the meeting room 6, bot identification information (e.g., token), and group identification information for identifying a group to which a notification is to be sent. The bot identification information is sent in advance from the chat server 10 as identification information of a bot when the bot of the meeting management server 30 is created. Furthermore, an account of an individual such as the reserving person may be designated in some cases. In addition, the communication unit 11 transmits, to the meeting management server 30, that scheduled participants have read the information regarding reservation of the meeting room 6 or responses from the scheduled participants to the displayed information regarding reservation of the meeting room 6.

On the basis of the bot identification information and the group identification information sent from the meeting management server 30, the text processing unit 12 transmits the information regarding reservation of the meeting room 6 to scheduled participants who belong to the group as information of a message of the bot. This information may be transmitted to all the scheduled participants or to the reserving person or a user to which a notification is sent.

The text processing unit 12 can transmit a so-called push notification. A known mechanism provided by each OS is used for the push notification.

The chat server 10 further includes a storage unit 19. The storage unit 19 is implemented by the memory 202, the HDD 209, and the like in FIG. 5. The storage unit 19 stores a group information DB 191.

TABLE 2
Group Information DB:

| | | Member | Member | Member | Member | |
|---|---|---|---|---|---|---|
| Work Space | Channel | Account 1 | Account 2 | Account 3 | Account 4 | Bot Account |
| http://sample.com/1 | #marketing | a@chat.com | b@chat.com | c@chat.com | d@chat.com | robo@chat.com |
| http://sample.com/2 | #team1 | b@chat.com | d@chat.com | | | |
| http://sample.com/3 | #ip | f@chat.com | g@chat.com | h@chat.com | | robo@chat.com |
| . . . | . . . | . . . | . . . | . . . | . . . | . . . |

Table 2 illustrates an example of group information stored in the group information DB 191. In the group information, accounts of members who belong to the same group are registered. In the group information, member accounts 1 to n (n=4 in Table 2) and a bot account are registered in association with a work space and a channel.

The work space is identification information for identifying an organization such as a company or an office. In this embodiment, a plurality of members belong to a workspace (e.g., Company A). Examples of the workspace include a uniform resource locator (URL). Alternatively, any suitable information other than the URL is used as the workspace, provided that the information is unique. Furthermore, the work space has a plurality of channels in accordance with a purpose of a chat or the like. A channel is a group of members among whom information to be shared is exchanged, such as a group for Product A and a group for Product B. One or more members of the members belonging to the workspace belong to the channel. That is, the notification destination is identified on the basis of the work space and the channel. However, the method for identifying the notification destination differs depending on the chat system. Thus, if there is identification information by which a group is uniquely identified, the information may be used alone. Alternatively, three or more pieces of information may be used for identification.

The uniqueness of each channel is guaranteed. The member accounts 1 to n are accounts of members in the channel and published by the chat server 10. In this embodiment, as a member to which the information regarding reservation of the meeting room 6 is sent, a bot is registered. The bot is, in other words, an agent of the meeting management server 30 or an imaginary member. A message (text) of the bot is transmitted to terminal apparatuses 60 of the member accounts 1 to n.

The work space and the channel are managed by the meeting management server 30 and are information for identifying the group to which participants belong.

### Meeting Management Server

The meeting management server 30 includes a communication unit 31, an information associating unit 32, a reservation information obtaining unit 33, a notification determining unit 34, a control information generating unit 35, a control information responding unit 36, a meeting information sending unit 37, a check-in managing unit 38, a device communication unit 39, and a reservation information transmitting unit 41. Each of these functional units included in the meeting management server 30 is a function or means implemented by any of the component categories illustrated in FIG. 5 being operated in accordance with a command from the CPU 201 executing the program 209p that is loaded from the HDD 209 to the memory 202. The program 209p may be distributed by being stored in a storage medium or may be distributed from a server for program distribution.

The communication unit 31 transmits/receives various kinds of information to/from the reservation management server 20, the chat server 10, the registration terminal 50, and the terminal apparatus 60. The communication unit 31 includes a transmitting unit 31a and a receiving unit 31b. The receiving unit 31b receives the reservation information from the reservation management server 20 and receives a request for the reservation information from the meeting-room terminal 90. In addition, the receiving unit 31b receives a check-in request from the meeting-room terminal 90. The receiving unit 31b also accepts association of a group and accounts used by the chat system from the registration terminal 50 operated by the administrator. The transmitting unit 31a transmits the information regarding reservation of the meeting room 6 to the chat server 10 and transmits the reservation information to the meeting-room terminal 90. In addition, the communication unit 31 performs bidirectional communication with the bidirectional communication apparatus 130.

The information associating unit 32 mainly performs processing regarding registration in advance. That is, the information associating unit 32 accepts registration of a domain from the registration terminal 50 operated by the administrator or the like, registers the domain in a customer domain DB 495, and registers the work space and channel in the chat system and accounts used by the reservation management server 20, transmitted from the registration terminal 50 or the like, in association with each other in an associated information DB 491.

The reservation information obtaining unit 33 designates an account of a customer that uses the resource reservation system 100, obtains the reservation information from the reservation management server 20, and registers the reservation information in a meeting management information DB 493 as meeting management information. The reservation information obtaining unit 33 may designate an account in the registered or updated reservation information that has been sent from the reservation management server 20 or may designate a given account. At least part of the reservation information from the reservation management server 20 is stored in the meeting management information DB 493. The reservation information obtaining unit 33 obtains, from the reservation information held by the reservation management server 20, reservation information for a predetermined period from the present to the future. The predetermined period is determined depending on the period over which the information regarding reservation of the meeting room 6 in which meetings will be held is sent.

The notification determining unit 34 determines whether there is any reservation of which the start time satisfies a notification condition in the meeting management information. For example, referring to a notification setting DB 496, the notification determining unit 34 determines to send a notification at a set date and time by counting backwards from the reserved start time. Alternatively, upon the reservation information obtaining unit 33 obtaining the reservation information from the reservation management server 20, the notification determining unit 34 may generate a task for sending information regarding reservation and register the task in a queue. The task stored in a queue is executed at the execution time (time for reminder).

Note that in a case where bots have the respective different roles, such as a bot for reminder and a bot for accepting reservation, the bot is specified in accordance with processing.

If the notification determining unit 34 determines to send a notification, the meeting information sending unit 37 designates the bot identification information (e.g., token for slack) and the group identification information and requests the chat server 10 to send the information regarding reservation of the meeting room 6. Note that the notification is sent a couple of times, and meeting identification information is included in at least one notification. The meeting identification information is information used by the meeting management server 30 to confirm that participants have a right to use during the period of reservation of the meeting room 6. The meeting information sending unit 37 generates the meeting identification information at least before a final notification. Note that the meeting identification information is registered in a meeting identification information DB 494.

Referring to the meeting management information, the control information generating unit 35 generates control information of the electronic device 70 and registers the control information in a control information DB 497. For example, at a few minutes before the meeting start time, the control information generating unit 35 generates control information for turning on the electronic device 70, and upon detecting check-out, the control information generating unit 35 generates control information for turning off the electronic device 70. The control information is stored in the control information DB 497.

The control information responding unit 36 accepts an inquiry from the meeting-room terminal 90 in the meeting room 6 as to whether there is control information. Referring to the control information DB 497, the control information responding unit 36 transmits control information corresponding to the meeting room 6 to the meeting-room terminal 90.

The check-in managing unit 38 manages check-in and check-out of a meeting room. In addition, the check-in managing unit 38 mainly registers a status of a meeting in response to check-in and check-out in the meeting management information DB 493. Check-in becomes available five or ten minutes before the start time of a meeting specified based on the reservation ID. Then, in a case where a pair of a meeting-room ID and the meeting identification information transmitted from the meeting-room terminal 90 is registered in the meeting identification information DB 494, check-in is permitted.

The device communication unit 39 obtains device information from the management apparatus 110 and communicates with the meeting-room terminal 90 through the bidirectional communication apparatus 130. The device information will be specifically described later.

In response to a request from the meeting-room terminal 90, the reservation information transmitting unit 41 transmits the reservation information (the meeting management information) stored in the meeting management information DB 493. The reservation information transmitting unit 41 may transmit the reservation information in the JSON format, XML format, Comma-Separated Values (CSV) format, or the like. Since the reservation information is repeatedly transmitted, a format with low capacitance is advantageous.

The meeting management server 30 further includes a storage unit 49. The storage unit 49 is implemented by the memory 202, the HDD 209, and the like in FIG. 5. The storage unit 49 stores the associated information DB 491, the meeting management information DB 493, the meeting identification information DB 494, the customer domain DB 495, the notification setting DB 496, the control information DB 497, and a meeting-room setting information DB 498.

TABLE 3
Associated Information DB:

| | | Member | Member | Member | Member |
|---|---|---|---|---|---|
| Work Space | Channel | Account 1 | Account 2 | Account 3 | Account 4 |
| http://sample.com/1 | #marketing | a@xfood.com | b@xfood.com | c@xfood.com | d@xfood.com |
| | | a@chat.com | b@chat.com | c@chat.com | d@chat.com |
| http://sample.com/2 | #team1 | f@xfood.com | g@xfood.com | h@xfood.com | |
| | | f@chat.com | g@chat.com | h@chat.com | |
| . . . | . . . | . . . | . . . | . . . | . . . |

Table 3 illustrates an example of associated information stored in the associated information DB 491. In the associated information, an account of a reservation management system and a group in a chat system are associated with each other. The associated information has items that are a work space, a channel, and the member accounts 1 to n (n=4 in Table 3). The work space and the channel are as above. As the member accounts 1 to n, accounts of participants published by the reservation management server 20 are registered. In addition, as illustrated in Table 3, accounts in a chat system may be registered. In order to notify a group, information for identifying an account of a user in the reservation management server 20, the user being a user who has reserved a meeting in the reservation management server 20, a group as a notification destination, and a channel (work space and channel name in this embodiment) may be used, and accounts of all members who belong to the group are not necessarily registered. However, in a case where a notification is to be sent to an individual user, since account information in each chat system is expected, the account information may be registered as in Table 3.

TABLE 4
Meeting Management Information DB:

| | Reserving | | | | | Scheduled | |
|---|---|---|---|---|---|---|---|
| Reservation | Person's | Meeting | Meeting- | | | Participants' | |
| ID | Account | Name | Room ID | Start Time | End Time | Accounts | Status |
| 001 | a@xfood.com | Product Z | K-001 | 2017/07/07 | 2017/07/07 | b@xfood.com | Checked In |
| | | Development | | 10:00 | 12:00 | c@xfood.com | |
| | | Meeting | | | | d@xfood.com | |
| 002 | e@xfood.com | Product Y | K-001 | 2017/07/07 | 2017/07/07 | f@xfood.com | Notification |
| | | Development | | 13:00 | 14:00 | g@xfood.com | Sent |
| | | Meeting | | | | | |
| . . . | . . . | . . . | . . . | . . . | . . . | . . . | . . . |

Table 4 illustrates an example of the meeting management information stored in the meeting management information DB 493 of the meeting management server 30. Since the reservation information is stored in the meeting management information DB 493, differences from the reservation information DB 291 in Table 1 will be described in Table 4. The meeting management information in Table 4 has items that are a written name of the reserving person, a name of belonging of the reserving person, written names of participants, names of belonging of the participants, and a status. The written name of the reserving person is a name of the reserving person or the like. The name of belonging of the reserving person is a name of an office to which the reserving person belongs. The written names of participants are names of participants or the like. The names of belonging of participants are names of offices to which participants belong. The meeting management server 30 holds or can use user information in which the account, the written name, the name of belonging, and the like are associated. Thus, if the account is known, the other information turns out. Note that upon transmission from the reservation management server 20, the written name of the reserving person, the name of belonging of the reserving person, the written names of participants, and the names of belonging of participants may be included.

The status indicates a status of reservation. For example, the status registered in the meeting management information of Table 4 indicates whether a notification of the information about the reservation of the meeting room 6 has been sent, whether the use of the meeting room has been confirmed, whether the check-in operation has been performed, whether the check-out operation has been performed, or whether the reservation has been cancelled.

TABLE 5
Meeting Identification Information DB:

| | | Meeting Identification |
|---|---|---|
| Reservation ID | Meeting-Room ID | Information |
| 001 | K-001 | 1234 |
| 002 | K-002 | 5678 |
| . . . | . . . | . . . |

Table 5 illustrates an example of meeting identification information management information stored in the meeting identification information DB 494. In the meeting identification information management information, the meeting identification information is managed for each reservation of the meeting room 6. The meeting identification information management information has items that are a reservation ID, a meeting-room ID, and the meeting identification information. These items are the same as those in the reservation information (the reservation information received from the reservation management server 20) except for the status and are described above. Therefore, description will be omitted. Note that the reservation ID is registered so as to identify reservation of the same meeting room 6.

TABLE 6
Customer Domain DB:

| | Customer Administrator's |
|---|---|
| Customer's Domain Name | Account |
| xfood.com | a@xfood.com |
| ycar.com | f@ycar.com |
| . . . | . . . |

Table 6 illustrates an example of customer domain information stored in the customer domain DB 495. In the customer domain information, a customer's domain and a customer administrator's account are managed. In the customer domain information, a customer's domain name and a customer administrator's account are registered in association with each other. The customer's domain in Table 6 is a domain of an account (email address) published by the reservation management server 20. In addition, the administrator's account is an account of an administrator (representative) of the customer. The reservation management server 20 issues the accounts in Table 6.

TABLE 7
Notification Setting DB:

| Customer's Domain Name | Notification Setting |
|---|---|
| xfood.com | one day before |
| ycar.com | 12 hours before |
| . . . | . . . |

Table 7 illustrates an example of notification setting information stored in the notification setting DB 496. The notification setting information holds setting regarding a notification for each customer. In the notification setting information, the customer's domain name and the notification setting are registered in association with each other. As the notification setting, the time before the meeting start time for sending the information regarding reservation of the meeting room 6 is set. Alternatively, a predetermined date and time may be set. In addition, the time is not necessarily a single time, and a plurality of times of notification setting may be registered for a single customer.

TABLE 8
Control Information DB:

| Meeting-Room ID | Control Content |
|---|---|
| K-001 | Turn ON |
| K-002 | Turn OFF |
| . . . | . . . |

Table 8 illustrates an example of control information stored in the control information DB 497. The control information is information for controlling the electronic device 70 in the meeting room 6. The control information has items that are a meeting-room ID and a control content. The control content is specific information regarding how to control the electronic device 70. The meeting management server 30 can set a detailed control content for each electronic device 70. The time for control is not registered because it is difficult to transmit the control information from the meeting management server 30 in the outside network to the meeting-room terminal 90. When the meeting-room terminal 90 accesses the meeting management server 30, if the control information has been generated, the control content is transmitted.

TABLE 9
Meeting-Room Setting Information DB:

| | | | | | | Number of |
|---|---|---|---|---|---|---|
| | | | State of | | | Meeting-Room |
| Customer | Meeting- | Meeting- | Meeting-Room | Authentication | Management | Terminals That |
| ID | Room Name | Room ID | Terminal | Key | Start Flag | Can Be Registered |
| G-001 | Meeting | K-001 | Connected | ***** | True | 1 |
| | Room A | | | | | |
| | Meeting | K-002 | Before Setup | ***** | False | 1 |
| | Room B | | | | | |
| | Meeting | K-003 | Disconnected | ***** | True | 2 |
| | Room C | | | | | |

Table 9 illustrates an example of meeting-room setting information stored in the meeting-room setting information DB 498. The meeting-room setting information is information regarding setting of each meeting room. The meeting-room setting information has items that are a meeting-room name, a meeting-room ID, a state of the meeting-room terminal 90, an authentication key, a management start flag, and the number of meeting-room terminals 90 that can be registered, each in association with a customer ID.
The meeting-room name is a typical name of a meeting room recognized by participants of the meeting and is, for example, a name presented at the entrance of the meeting room.
The meeting-room ID is identification information for uniquely identifying the meeting room as described above. For simplicity, the meeting-room ID may be the same as that in the reservation management server 20. By providing a conversion table, the administrator can set a meeting-room ID different from that in the reservation management server 20.
The state of the meeting-room terminal 90 indicates whether initial setting of the meeting-room terminal 90 is completed, whether communication is possible, or the like. “Connected” means a state where communication can be confirmed within a fixed period; “before setup” means before initial setting; and “disconnected” means a state where no communication is performed for a fixed period or longer.
The authentication key is authentication information used by the meeting management server 30 for authenticating the meeting-room terminal 90. By initial setting, the authentication key is transmitted to the meeting-room terminal 90. The authentication key is a combination of numerals, alphabetical letters, symbols, and the like that is too long to be identified by brute-force attack. The authentication key may be determined by the meeting management server 30 or the administrator.
The management start flag indicates whether the meeting management server 30 starts management of the meeting room after completion of initial setting of the meeting-room terminal 90 (True: start, False: not start). The management start flag can prevent disadvantages generated by a time lag from the completion of initial setting until the disposition of the meeting-room terminal 90. Details will be described later.
The number of meeting-room terminals 90 that can be registered is the number of meeting-room terminals 90 that can be associated with a single meeting room. No problem arises if there is a meeting-room terminal 90 in a single meeting room. However, if an abnormality occurs in the meeting-room terminal 90, it is difficult to check in the meeting room for repair. Thus, the administrator may wish to associate a plurality of meeting-room terminals 90 with a single meeting room. Accordingly, even if the authentication key leaks, since the terminal IDs are the same and the number thereof is determined, the reservation information can be prevented from leaking, for example. The default value of the number of the meeting room terminals 90 can be either one or n (n≥2).

The meeting-room name and the meeting-room ID are determined in advance or may be set by the administrator. The meeting-room name and the meeting-room ID transmitted from the reservation management server 20 may be used. Although the initial state of the meeting-room terminal 90 (immediately after setting by a provider) is before setup, the state transitions depending on a communication status. At the time of initial setting, for example, the authentication key is numbered and set by the meeting management server 30. The management start flag is set by the administrator on a setting screen, which will be described later, for example. The number of meeting-room terminals 90 that can be registered can be similarly set by the administrator. In many cases, the number of meeting-room terminals 90 that can be registered is 1 or more. If the number is set to 1, a single meeting-room terminal 90 can be registered for a single meeting room.

### Registration Terminal

The registration terminal 50 includes a communication unit 51, an operation accepting unit 52, and a display controller 53. Each of these functional units included in the registration terminal 50 is a function or means implemented by any of the components illustrated in FIG. 5 being operated in accordance with a command from the CPU 201 executing the program 209p that is loaded from the HDD 209 to the memory 202. The program 209p is distributed by being stored in a storage medium or is distributed from a server for program distribution.

The registration terminal 50 is a terminal used by the administrator for setting various settings regarding the meeting room via a web page provided by the meeting management server 30. Browser software operates on the registration terminal 50.

The communication unit 51 included in the registration terminal 50 transmits/receives various kinds of information to/from the meeting management server 30 or the like. For example, the communication unit 51 receives the meeting-room setting information of each meeting room and transmits information that is set by the administrator regarding the meeting-room setting information.

The operation accepting unit 52 accepts various operations on the registration terminal 50. The display controller 53 analyzes various kinds of screen information from the meeting management server 30 and displays a screen on the LCD 206.

### Terminal Apparatus

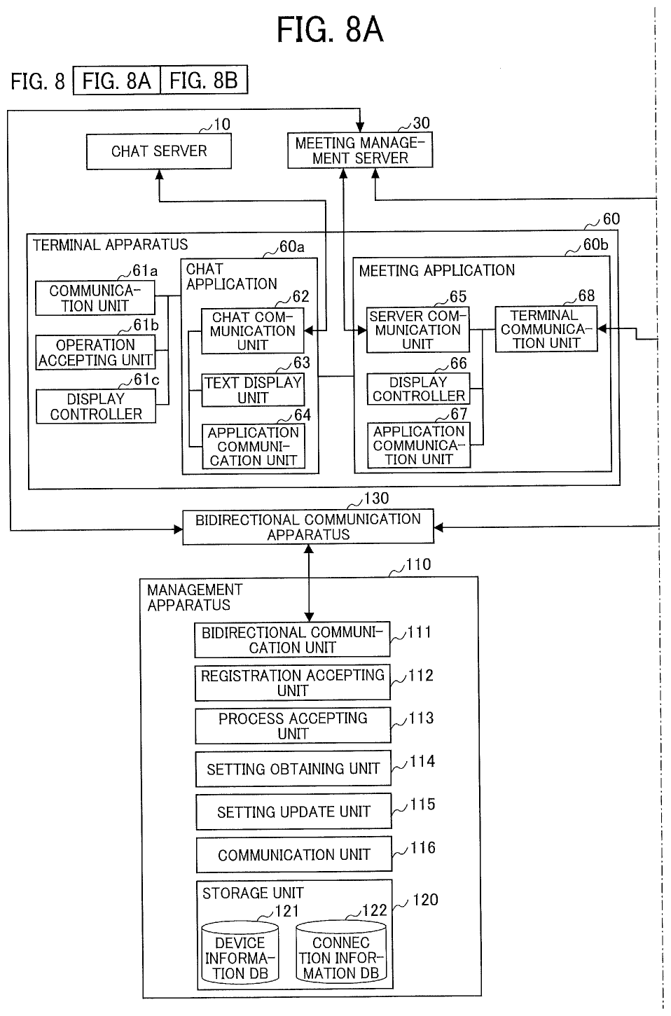

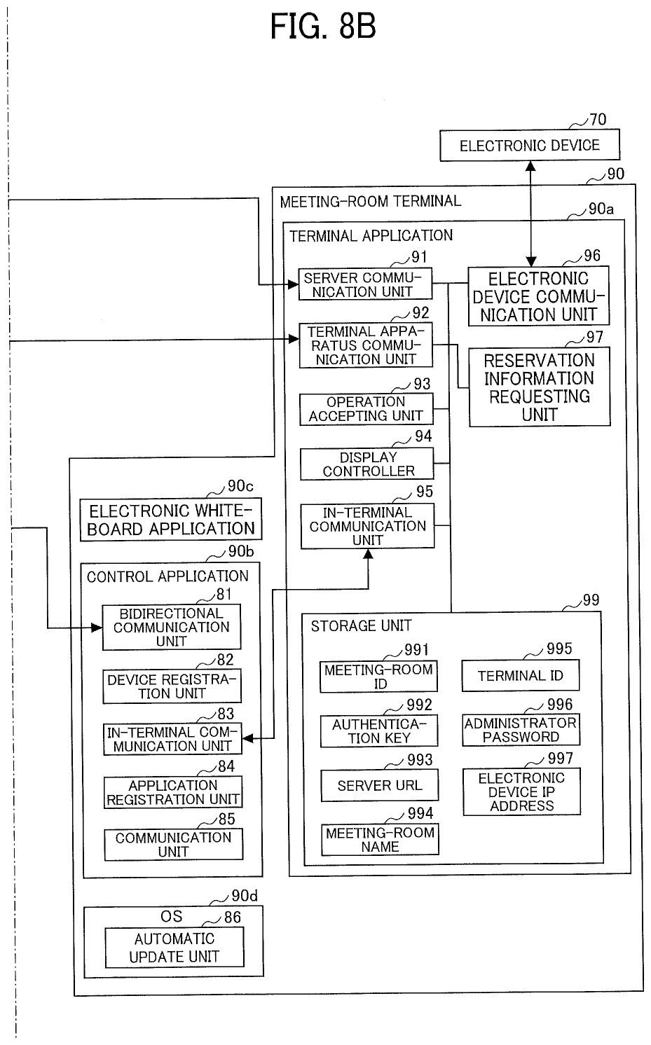

FIG. 8A and FIG. 8B are block diagrams illustrating an example of functional configurations of the terminal apparatus 60, the meeting-room terminal 90, and the management apparatus 110. Functions of the electronic device 70 will be described as necessary.

The terminal apparatus 60 includes a communication unit 61a, an operation accepting unit 61b, a display controller 61c, a chat communication unit 62, a text display unit 63, an application communication unit 64, a server communication unit 65, a display controller 66, an application communication unit 67, and a terminal communication unit 68. Each of these functional units included in the terminal apparatus 60 is a function or means implemented by any of the component categories illustrated in FIG. 5 being operated in accordance with a command from the CPU 201 executing the program 209p that is loaded from the HDD 209 to the memory 202. The program 209p is distributed by being stored in a storage medium or is distributed from a server for program distribution. Since a chat application 60a and a meeting application 60b operate on the terminal apparatus 60, the program 209p includes the chat application 60a and the meeting application 60b.

The communication unit 61a transmits/receives various kinds of information to/from the meeting management server 30 and the reservation management server 20. The communication unit 61a is implemented by the CPU 201 in FIG. 5 executing the program 209p and controlling the network driver 205, for example.

The operation accepting unit 61b accepts various operations of participants on the terminal apparatus 60. The operation accepting unit 61b is implemented by the CPU 201 in FIG. 5 executing the program 209p and controlling the input device 210, for example.

The display controller 61c interprets screen information of various screens and displays a screen on the LCD 206. The operation accepting unit 61b and the display controller 61c have, for example, a browser function and can execute a web application. For example, the display controller 61c displays a reservation setting screen received from the reservation management server 20, and the operation accepting unit 61b accepts reservation information that is set by the reserving person.

The chat communication unit 62 of the chat application 60a transmits/receives various kinds of information to/from the chat server 10. In this embodiment, the chat communication unit 62 receives the information regarding reservation of the meeting room 6 from the chat server 10 and notifies the chat server 10 that the information has been read, the meeting room 6 is to be used or canceled, and the like. The chat communication unit 62 is implemented by the CPU 201 in FIG. 5 executing the program 209p and controlling the network driver 205, for example.

The text display unit 63 of the chat application 60a displays text (the information regarding reservation of the meeting room 6) transmitted from the chat server 10. For example, the text is displayed as if the message sender is a bot and the bot inputs the text. The text display unit 63 is implemented by the CPU 201 in FIG. 5 executing the chat application 60a, for example.

The application communication unit 64 of the chat application 60a calls the meeting application 60b and also transmits the meeting identification information to the meeting application 60b. When sending the information regarding reservation of the meeting room 6, since the chat server 10 has transmitted information for identifying the meeting application 60b to the terminal apparatus 60, the chat application 60a designates the meeting application 60b and requests the OS to send the meeting identification information. The OS can start the meeting application 60b. The application communication unit 64 is implemented by the CPU 201 in FIG. 5 executing the chat application 60a, for example.

The server communication unit 65 of the meeting application 60b communicates with the meeting management server 30. A two-dimensional code including the meeting identification information is obtained from the meeting management server 30, for example. The server communication unit 65 is implemented by the CPU 201 in FIG. 5 executing the meeting application 60b, for example. The two-dimensional code is used for authentication at the time of check-in. A several-digit number for authentication may alternatively be used.

The display controller 66 of the meeting application 60b displays the two-dimensional code including the meeting identification information or the like on the LCD 206. The display controller 66 is implemented by the CPU 201 in FIG. 5 executing the meeting application 60b and controlling the graphics driver 204, for example.

The application communication unit 67 of the meeting application 60b obtains various kinds of information (e.g., the meeting identification information included in the information regarding reservation of the meeting room 6) from the chat application 60a through the OS. The application communication unit 67 is implemented by the CPU 201 in FIG. 5 executing the meeting application 60b, for example.

The terminal communication unit 68 communicates with the meeting-room terminal 90 and transmits the meeting identification information or the like. The terminal communication unit 68 detects the presence of the meeting-room terminal 90 by short-range wireless communication such as Bluetooth (registered trademark), and upon detection of the meeting-room terminal 90, transmits the meeting identification information. In addition, the terminal communication unit 68 provides a function of displaying the two-dimensional code to the meeting-room terminal 90. The terminal communication unit 68 is implemented by the CPU 201 in FIG. 5 executing the meeting application 60b, for example.

### Meeting-Room Terminal

In the meeting-room terminal 90, the following applications are installed: the terminal application 90a, the control application 90b, and the electronic whiteboard application 90c, which are operated on the OS 90d and have the illustrated functions. Note that the electronic whiteboard application 90c is an application that enables handwritten input to the meeting-room terminal 90. In addition, at least the terminal application 90a is installed in the meeting-room terminal 90, and the number of control target applications 89 may be three or more.

As functions of the terminal application 90a, the meeting-room terminal 90 includes a server communication unit 91, a terminal apparatus communication unit 92, an operation accepting unit 93, a display controller 94, an in-terminal communication unit 95, an electronic device communication unit 96, and a reservation information requesting unit 97. Each of these functional units included in the meeting-room terminal 90 is a function or means implemented by any of the components illustrated in FIG. 6 being operated in accordance with a command from the CPU 601 executing the program 604p that is loaded from the EEPROM 604 to the RAM 603. The program 604p is distributed by being stored in a storage medium or is distributed from a server for program distribution.

The server communication unit 91 communicates with the meeting management server 30 by using a server URL 993 as an address. Since the meeting-room terminal 90 is present in an in-house network, it is difficult for the meeting management server 30 to communicate with the meeting-room terminal 90 (if the bidirectional communication apparatus 130 is not used). Thus, the server communication unit 91 communicates with the meeting management server 30 by a communication technique such as polling (regularly communicating with the meeting management server 30) or WebSocket. The server communication unit 91 may perform communication using a communication protocol such as, but not limited to, Hypertext Transfer Protocol (HTTP) or the like.

The server communication unit 91 according to this embodiment receives reservation information and transmits, to the meeting management server 30, meeting identification information received by the terminal apparatus communication unit 92 from the terminal apparatus 60 or meeting identification information manually input at the time of check-in. In addition, the server communication unit 91 receives control information from the meeting management server 30.

The terminal apparatus communication unit 92 communicates with the terminal apparatus 60. In this embodiment, the terminal apparatus communication unit 92 receives the meeting identification information or the like. In a case where the meeting identification information is manually input, the terminal apparatus communication unit 92 may be omitted in some cases. The terminal apparatus communication unit 92 is implemented by the CPU 601 in FIG. 6 executing the program 604p to control the short-range wireless communication device 615 or the RF tag reader/writer 622, for example.

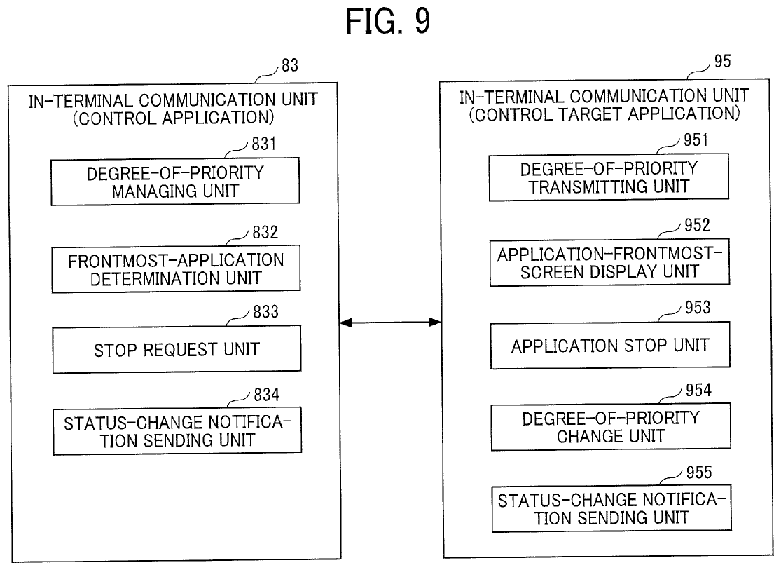

The in-terminal communication unit 95 communicates with other applications (the electronic whiteboard application 90c and the control application 90b) in the meeting-room terminal 90. For communication, a function of the OS may be used as appropriate. Detailed functions of the in-terminal communication unit 95 will be described with reference to FIG. 9.

The electronic device communication unit 96 communicates with the electronic device 70. In this embodiment, the electronic device communication unit 96 transmits the control information received by the server communication unit 91 to the electronic device 70. The electronic device communication unit 96 is implemented by the CPU 601 in FIG. 6 executing the program 604p to control the wireless LAN communication device 613, for example.

The display controller 94 displays, on the display 616, a screen generated by the terminal application 90a. This screen is a standby screen on which check-in, check-out, and the like is feasible. The display controller 94 in this embodiment determines whether reservation information is associated with private setting. If private setting is associated, the display controller 94 hides private target items designated by the private setting or replaces the private target item with a preset expression.

The operation accepting unit 93 accepts various operations on the meeting-room terminal 90. For example, the operation accepting unit 93 accepts check-in, meeting identification information that is manually input, or check-out.

At periodical timing for obtaining the reservation information, the reservation information requesting unit 97 repeatedly transmits, to the meeting management server 30, a meeting-room ID 991 and an authentication key 992 by using the server URL 993 stored in a storage unit 99 as an address through the server communication unit 91. As a response to this, the reservation information requesting unit 97 obtains the reservation information through the server communication unit 91. The reservation information may be obtained when any change is made. The timing is a period of a few seconds to a few minutes. The reservation information can be updated earlier if the period is shorter, but the communication load is higher. Thus, the period is determined balancing both points. In this embodiment, the period is 30 seconds, for example. In addition, for example, at least the meeting management information (the reservation information) of the meeting room 6 of the day can be received through the server communication unit 91.

The meeting-room terminal 90 further includes the storage unit 99. The storage unit 99 is implemented by the ROM 602, the EEPROM 604, and the like in FIG. 6. The storage unit 99 stores the meeting-room ID 991, the authentication key 992, the server URL 993, a meeting-room name 994, a terminal ID 995, an administrator password 996, and an Internet protocol (IP) address 997 of the electronic device 70. These are part or all of setting information that is set in the meeting-room terminal 90 (the terminal application 90a). In addition, the meeting-room ID 991, the authentication key 992, and the server URL 993 are information used for communication with the meeting management server 30.

The terminal ID 995 is identification information of the meeting-room terminal 90. The terminal ID is used by the meeting management server 30 to identify the meeting room terminals 90 in order to prevent more than a preset number of meeting room terminals 90 from being connected to the meeting management server 30 in one meeting room. The terminal ID may be any unique identifier, such as a universally unique identifier (UUID) of the terminal application 90a or a media access control (MAC) address. The UUID is a unique identifier, and two or more items do not have the same value throughout the world even if specific management is not performed. The administrator password 996 is set by the administrator at the time of install or initial start of the terminal application 90a. The IP address 997 of the electronic device 70 is set by the administrator as appropriate.

In addition, as functions of the control application 90b, the meeting-room terminal 90 includes a bidirectional communication unit 81, a device registration unit 82, an in-terminal communication unit 83, an application registration unit 84, and a communication unit 85.

The bidirectional communication unit 81 performs bidirectional communication with the management apparatus 110 or the meeting management server 30 through the bidirectional communication apparatus 130. In response to the control application 90b having installed in the meeting-room terminal 90, the device registration unit 82 registers device information in the management apparatus 110 and the bidirectional communication apparatus 130. The in-terminal communication unit 83 performs bidirectional communication with the in-terminal communication unit 95 of the terminal application 90a. Detailed functions of the in-terminal communication unit 83 will be described with reference to FIG. 9.

The application registration unit 84 registers, in the management apparatus 110, application-related information installed in the meeting-room terminal 90. The communication unit 85 establishes a connection to the network N1 to communicate with other apparatuses not through the bidirectional communication apparatus 130.

### Management Apparatus

The management apparatus 110 includes a bidirectional communication unit 111, a registration accepting unit 112, a process accepting unit 113, a setting obtaining unit 114, a setting update unit 115, and a communication unit 116. Each of these functional units included in the management apparatus 110 is a function or means implemented by any of the component categories illustrated in FIG. 5 being operated in accordance with a command from the CPU 201 executing the program 209p that is loaded from the HDD 209 to the memory 202.

The bidirectional communication unit 111 performs bidirectional communication with the meeting-room terminal 90 through the bidirectional communication apparatus 130. The registration accepting unit 112 accepts requests for registering device information and application-related information from the control application 90b and registers the device information and the application-related information in a device information DB 121 and a connection information DB 122, respectively.

The process accepting unit 113 generates screen information of a remote setting screen, which will be described later, and transmits the screen information to the registration terminal 50 through the communication unit 116. The screen information is described in Hypertext Markup Language (HTML), Cascade Style Sheet (CSS), JavaScript (registered trademark), or the like. As a screen of a web application that operates on a browser in JavaScript (registered trademark), a remote setting screen is provided.

In response to a request from the meeting management server 30 or the administrator (the registration terminal 50), the setting obtaining unit 114 obtains setting information of the terminal application 90a or a degree of priority of the control application 90b through the bidirectional communication apparatus 130. In response to a request from the meeting management server 30 or the administrator (the registration terminal 50), the setting update unit 115 updates or changes the setting information of the terminal application 90a or degree of priority of the control application 90b through the bidirectional communication apparatus 130. The communication unit 116 establishes a connection to the network N2 and communicates with other apparatuses without through the bidirectional communication apparatus 130.

The management apparatus 110 further includes a storage unit 120. The storage unit 120 is implemented by the memory 202, the HDD 209, and the like in FIG. 5. The storage unit 120 stores the device information DB 121 and the connection information DB 122.

TABLE 10

| | | MAC | Installed | Application |
|---|---|---|---|---|
| No | Device ID | Address | Application ID | Version |
| 1 | ABC | XXXX | jp.co.aaaaa.app1 | 1.0 |
| | | | jp.co.aaaaa.app2 | 1.1 |
| 2 | DEF | YYYY | jp.co.aaaaa.app1 | 0.9 |
| 3 | GHI | ZZZZ | jp.co.aaaaa.app3 | 1.5 |

Table 10 schematically illustrates the device information stored in the device information DB 121. In the device information, serial numbers are assigned to records, and further, device IDs are associated with MAC addresses, installed application IDs, and application versions. The device ID is information for identifying or specifying the meeting-room terminal 90 (or the control application 90b). The MAC address is a physical address uniquely assigned to hardware of a network device, such as a LAN card, set for identifying each node (the meeting-room terminal 90) on a network. The installed application ID is identification information for identifying an application (e.g., the terminal application 90a, the control application 90b, or the electronic whiteboard application 90c) installed in the meeting-room terminal 90. The application version is a version of each installed application.

In the device information, the device ID or a set of the device ID and the application ID is communication information used by the management apparatus 110 to communicate with the meeting-room terminal 90. A connection ID, which will be described below, may also be included in the communication information. The device ID is the communication information in this embodiment.

TABLE 11

| No | Device ID | Connection ID | Connection State |
|---|---|---|---|
| 1 | ABC | 1111 | Disconnected |
| 2 | ABC | 2222 | Connected |
| 3 | DEF | 3333 | Connected |
| 4 | GHI | 4444 | Connected |

Table 11 schematically illustrates connection information stored in the connection information DB 122. In the connection information, serial numbers are assigned to records, and further, device IDs are associated with connection IDs and connection states. The connection ID is information used by the bidirectional communication apparatus 130 to determine whether the management apparatus 110 has the authority to communicate with the meeting-room terminal 90. This kind of information may also be referred to as an access token. As the connection state, the state (connected, disconnected) of communication with the meeting-room terminal 90 is registered. The connection ID may be the communication information used by the management apparatus 110 to communicate with the meeting-room terminal 90.

### OS

The OS 90d includes an automatic update unit 86. The automatic update unit 86 communicates with the application server 140, downloads, from the application server 140, a new version of the control application 90b, the terminal application 90a, or the electronic whiteboard application 90c, installed in the meeting-room terminal 90, and updates an old-version application. Note that the download and update of the application is performed while the application is stopped.

Functions of in-Terminal Communication Units

FIG. 9 is an example of a functional block diagram illustrating functions of the in-terminal communication units 83 and 95. As described above, the in-terminal communication unit 83 of the control application 90b and the in-terminal communication unit 95 of a control target application 89 can communicate with each other inside the terminal. For example, for an OS called Android (registered trademark, hereinafter omitted), a function called intent communication is known.

First, the in-terminal communication unit 83 of the control application 90b includes a degree-of-priority managing unit 831, a frontmost-application determination unit 832, a stop request unit 833, and a status-change notification sending unit 834. First, from each of the control target applications 89, the in-terminal communication unit 83 obtains a degree of priority in order to determine an application to be displayed on the frontmost screen (including a case of passive reception). The degree-of-priority managing unit 831 manages the degree of priority in association with the control target application 89. In addition, the degree-of-priority managing unit 831 may accept setting of the degree of priority of the control target application 89 from the management apparatus 110.

The frontmost-application determination unit 832 determines that the control target application 89 having the highest degree of priority is to be displayed on the frontmost screen, and the in-terminal communication unit 83 sends a frontmost-screen display notification to the control target application 89. The degrees of priority of control target applications 89 change in accordance with statuses of control target applications 89. That is, if a status of a control target application 89 is changed, the degree of priority of another control target application 89 may change. If a status of a control target application 89 is changed, the degree of priority of this control target application 89 may change.

The stop request unit 833 notifies control target applications 89 having the second highest and subsequent degrees of priority determined by the frontmost-application determination unit 832 that the control target applications 89 are to be stopped. The stopped control target applications 89 can be started again by receiving a frontmost-screen display notification from the frontmost-application determination unit 832. Alternatively, a start request unit may additionally be provided.

By using a function of the in-terminal communication unit 83, if the in-terminal communication unit 83 receives a status-change notification from a control target application 89 for which the status is changed, the status-change notification sending unit 834 sends a status-change notification to other control target applications 89 than the control target application that sent the status-change notification. Thus, the control target applications 89 can change the degrees of priority.

The in-terminal communication unit 95 of the control target application 89 includes a degree-of-priority transmitting unit 951, an application-frontmost-screen display unit 952, an application stop unit 953, a degree-of-priority change unit 954, and a status-change notification sending unit 955. By using a function of the in-terminal communication unit 95, the degree-of-priority transmitting unit 951 transmits, to the control application 90b, the degree of priority of the control target application 89. An initial degree of priority is set for the control target application 89. The degree of priority is transmitted in response to start of the control target application 89 or a request from the control application 90b, for example.

If the status-change notification is received from the control application 90b or if the status of the control target application 89 is changed, the degree-of-priority change unit 954 changes the degree of priority of the control target application 89 as needed. The term “as needed” refers to a case where the status is changed to a predetermined status. Table 12 illustrates status-change notification degree-of-priority information held in each of the control target applications 89.

TABLE 12

| Content of Status-Change Notification | Degree of Priority |
|---|---|
| Meeting Start Status | 4 |
| Meeting End Status | 2 |

Table 12 is an example of the status-change notification degree-of-priority information. As illustrated in Table 12, the degree of priority is associated with a content of the status-change notification. In Table 12, setting the degree of priority to “4” is set for a meeting start status as the status-change notification, and setting the degree of priority to “2” is set for a meeting end status as the status-change notification. The meeting start status means a status (use start status) in which use of a resource that is a meeting room is started, and the meeting end status means a status (use end status) in which use of a resource that is a meeting room ends.

Referring back to FIG. 9, by using a function of the in-terminal communication unit 95, the status-change notification sending unit 955 detects a change in status in response to an operation of the control target application 89 and sends the status-change notification to the control application 90b. For example, the status-change notification sending unit 955 sends a notification of the meeting start status or the meeting end status.

Upon being notified that the control target application 89 is to be displayed on the frontmost screen from the control application 90b, the application-frontmost-screen display unit 952 displays the control target application 89 on a front screen of any other applications. Thus, the control target application 89 is displayed on the frontmost screen. Note that although the control application 90b has a screen (user interface), since the control application 90b is an application displaying a home screen, the screen of the control target application 89 is displayed on a front screen of the control application 90b. In addition, the control application 90b is not a target for which the degree of priority is compared (the control application 90b does not have a degree of priority).

Upon being notified that the control target application 89 is to be stopped from the control application 90b, the application stop unit 953 stops the control target application 89. The expression “stop the control target application 89” means to disenable a user from using the control target application 89 or may mean to set a state in which the control target application 89 can be updated.

Although the in-terminal communication units 83 and 95 have the functions in FIG. 9, the functions are included in the control application 90b or the terminal application 90a.

### Screen Transition Examples

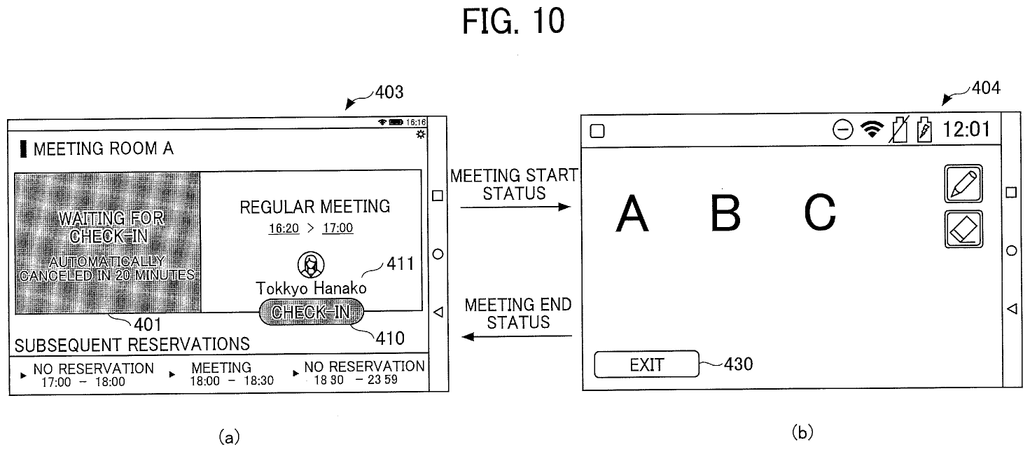

FIG. 10 illustrates a screen transition example of the meeting-room terminal 90. FIG. 10(a) illustrates a standby screen 403 displayed by a control target application 89A, and FIG. 10(b) illustrates an operation screen 404 displayed by a control target application 89B. Upon start of a meeting, the standby screen 403 transitions to the operation screen 404. Upon end of a meeting, the operation screen 404 transitions to the standby screen 403.

On the standby screen 403, “waiting for check-in” is displayed in a current status field 401, and a check-in button 410 is displayed. In addition, a reserving person is displayed in a reserving person name field 411. The check-in button 410 is used by a user to check in. Pressing of the check-in button 410 corresponds to an operation for status change (meeting start status).

The operation screen 404 is a screen of the electronic whiteboard application 90c and accepts the user's handwritten input. Upon start of a meeting, the operation screen 404 is automatically displayed, and thus, a whiteboard can become available without user operations. The operation screen 404 has an exit button 430. Pressing of the exit button 430 corresponds to an operation for status change (meeting end status) or an exiting operation. If the electronic whiteboard application 90c accepts the pressing of the exit button 430, the electronic whiteboard application 90c notifies the terminal application 90a, which is substantially the same as the terminal application 90a accepting the end of the meeting. Note that the terminal application 90a may directly accept the end of the meeting. For example, the terminal application 90a that is not displayed on the frontmost screen pops up the exit button 430.

For controlling the display of the exit button 430, the electronic whiteboard application 90c may display the exit button 430, or the terminal application 90a may display some UIs (including the exit button 430) of the terminal application 90a in a layer higher than the electronic whiteboard application 90c. Alternatively, for example, in response to a request from the terminal application 90a, the control application 90b or the OS may display the exit button 430. For example, while the operation screen 404 is displayed, some operation menus (including the exit button 430) of the terminal application 90a may be displayed somewhere on the operation screen 404.

In addition, the exit button 430 is displayed as a part of the terminal application 90a on the electronic whiteboard application 90c. If the pressing of the exit button 430 is accepted from a meeting participant, substantially the same exit process as that performed if the pressing is accepted by the terminal application 90a is performed. Alternatively, the exit button 430 may be popped up so as to inform participants of an exit time or a meeting end time.

### Display Control of Frontmost Screen

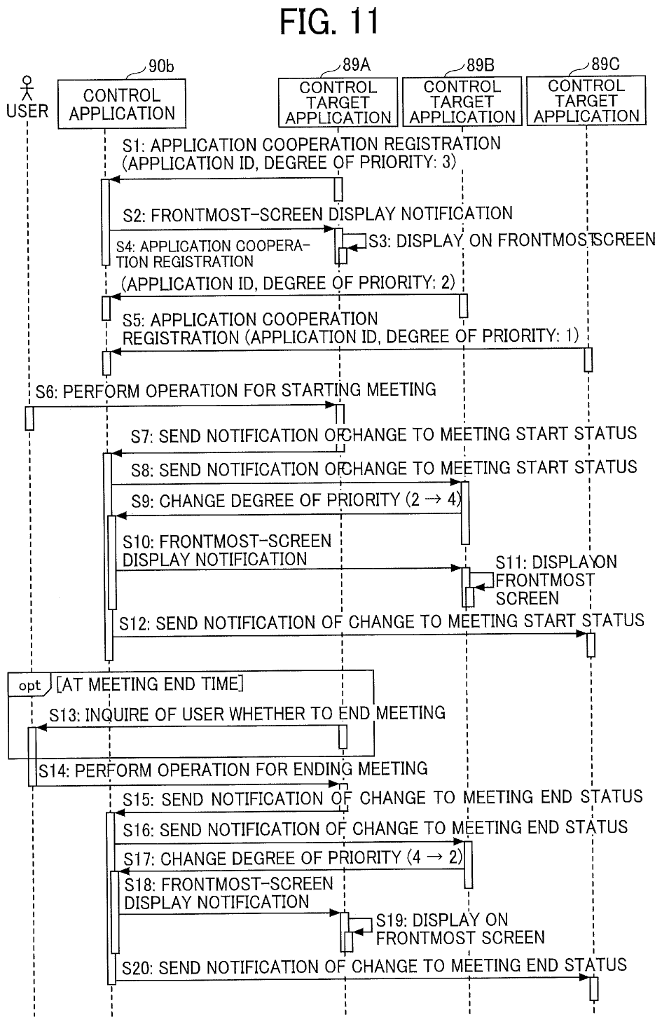

Now, control for displaying a control target application 89 on the frontmost screen will be described with reference to FIG. 11. FIG. 11 is a sequence diagram example illustrating a procedure in which the control application 90b displays the control target application 89 on the frontmost screen.

S1: At the start time, for example, the degree-of-priority transmitting unit 951 of the control target application 89A notifies the control application 90b of the degree of priority together with the application ID. Alternatively, at the start time, for example, if the control application 90b notifies the control target application 89A that cooperation is possible, the degree of priority may be sent. This sending is via the OS. Android has a mechanism called implicit intent, in which action and data (uniform resource identifier (URI)) are designated and broadcast is performed. Since an intent filter is set in advance in the control application 90b, the control application 90b can respond the action and data (URI).

In this example, the degree of priority of the control target application 89A is 3, the degree of priority of the control target application 89B is 2, and the degree of priority of a control target application 89C is 1. In addition, the larger the number is, the higher the degree of priority is.

S2: The in-terminal communication unit 83 of the control application 90b receives the application ID and the degree of priority, and the degree-of-priority managing unit 831 manages the degree of priority in association with the application ID. If the degree of priority is changed or added, the frontmost-application determination unit 832 determines a control target application 89 having the highest degree of priority at this time. Then, a frontmost-screen display notification is transmitted to the control target application 89 having the highest degree of priority. In this example, since the control target application 89A has the highest degree of priority, the frontmost-application determination unit 832 transmits the frontmost-screen display notification to the control target application 89A. Note that the stop request unit 833 may transmit a stop request to the control target applications 89B and 89C.

S3: The in-terminal communication unit 95 of the control target application 89A receives the frontmost-screen display notification, and the application-frontmost-screen display unit 952 displays a screen of the control target application 89A on the frontmost screen of the display 616.

S4, S5: At the start time, for example, the degree-of-priority transmitting units 951 of the control target application 89B and 89C notify the control application 90b of the degrees of priority together with the application IDs. However, since the control target application 89 having the highest degree of priority is still the control target application 89A without change, the frontmost-screen display notification is not transmitted.

S6: A user (e.g., a meeting participant) performs an operation for starting a meeting on the control target application 89A. The operation for starting a meeting is check-in and corresponds to pressing of the check-in button 410 in FIG. 10. Note that the check-in operation is transmitted to the meeting management server 30, and the check-in managing unit 38 of the meeting management server 30 changes the status of the meeting-room information.

S7: The operation accepting unit 93 of the control target application 89A accepts the operation for starting a meeting. Thus, in accordance with a change in the status of the control target application 89A to “during meeting”, the status-change notification sending unit 955 notifies the control application 90b that the meeting status has become “meeting start status” (sends a status-change notification). Note that the control target application 89A may automatically send this notification at the meeting start time.

S8: The in-terminal communication unit 83 of the control application 90b receives the meeting status as being “meeting start status”, and the status-change notification sending unit 834 notifies the control target application 89B that the meeting status has become “meeting start status” (sends a status-change notification). This notification is sent to the control target application 89 that has sent to the control application 90b the degree of priority. In addition, the status-change notification may or may not be sent to the control target application 89A, which is the notification sender. It is desirable not to send the notification to the notification sender because it is obvious to the sender that the status has been changed.

S9: The in-terminal communication unit 95 of the control target application 89B receives the status-change notification. Since the control target application 89B is to be operated during a meeting, the control target application 89B notifies the control application 90b of increasing the degree of priority of the control target application 89B together with the application ID. In this example, on the basis of the status-change notification degree-of-priority information in Table 12, the degree-of-priority change unit 954 increases the degree of priority from 2 to 4, to become higher than the degree of priority of the control target application 89A.

S10: The in-terminal communication unit 83 of the control application 90b receives the changed degree of priority of the control target application 89B, and the degree-of-priority managing unit 831 manages the degree of priority together with the degrees of priority of the other control target applications 89. The frontmost-application determination unit 832 determines that the control target application 89 having the highest degree of priority is changed from the control target application 89A to the control target application 89B (in accordance with status change) and sends a frontmost-screen display notification to the control target application 89B. Note that the stop request unit 833 may transmit a stop request to the control target applications 89A and 89C.

S11: The in-terminal communication unit 95 of the control target application 89B receives the frontmost-screen display notification, and the application-frontmost-screen display unit 952 displays a screen of the control target application 89B on the frontmost screen.

S12: The status-change notification sending unit 834 of the control application 90b also notifies the other control target application 89, the control target application 89C, that the meeting status has become “meeting start status”. Since the degree of priority of the control target application 89C is not changed, the degree of priority is not sent to the control application 90b.

S13: At the meeting end time or slightly before the meeting end time, the display controller 94 of the control target application 89A displays a message on the display 616, the message inquiring of the user whether to end the meeting. If the meeting is ended before the meeting end time by a user operation, this message is not displayed.

S14: The user reads the message and performs an operation for ending the meeting on the control target application 89A (or the user actively performs the operation if the meeting is ended before the meeting end time). The operation for ending the meeting is check-out and corresponds to pressing of the exit button 430 in FIG. 10.

In accordance with the end time of reservation of the meeting room, the terminal application 90a displays the exit button 430 on a front screen of the electronic whiteboard application (meeting application) 90c under a predetermined condition. The predetermined condition is, for example, a condition in which, at a predetermined time before the end time of reservation of the meeting room, the electronic whiteboard application 90c is displayed on a front screen of the terminal application 90a. For example, the predetermined time may be set by a user or a designer. For example, the predetermined time may be set to ten minutes.

S15: The operation accepting unit 93 of the control target application 89A accepts this operation. Thus, the status of the control target application 89A is changed to the meeting end status, and accordingly, the status-change notification sending unit 955 notifies the control application 90b that the meeting status has become “meeting end status” (sends a status-change notification).

S16: The in-terminal communication unit 83 of the control application 90b receives the meeting status that has become “meeting end status”, and the status-change notification sending unit 834 notifies another control target application 89, the control target application 89B, that the meeting status has become “meeting end status” (sends a status-change notification).

S17: The in-terminal communication unit 95 of the control target application 89B receives the status-change notification. Since the control target application 89B is to be operated during a meeting, the control target application 89B determines that the control target application 89B does not have to be displayed on the frontmost screen any longer and notifies the control application 90b of decreasing the degree of priority of the control target application 89B together with the application ID. In this example, on the basis of the status-change notification degree-of-priority in Table 12, the degree-of-priority change unit 954 sets the degree of priority from 4 to 2 again.

S18: The in-terminal communication unit 83 of the control application 90b receives the changed degree of priority of the control target application 89B, and the degree-of-priority managing unit 831 manages the degree of priority together with the degrees of priority of the other control target applications 89. The frontmost-application determination unit 832 determines that the control target application 89 having the highest degree of priority is changed from the control target application 89B to the control target application 89A and sends a frontmost-screen display notification to the control target application 89A.

S19: The in-terminal communication unit 95 of the control target application 89A receives the frontmost-screen display notification, and the application-frontmost-screen display unit 952 displays a screen of the control target application 89A on the frontmost screen. Note that the stop request unit 833 may transmit a stop request to the control target applications 89B and 89C.

S20: The in-terminal communication unit 83 of the control application 90b receives the meeting status as being “meeting end status”, and the status-change notification sending unit 834 notifies the other control target application 89, the control target application 89C, that the meeting status has become “meeting end status” (sends a status-change notification). Since the degree of priority of the control target application 89C is not changed, the degree of priority is not sent to the control application 90b.

In the above manner, the applications of the meeting-room terminal 90 in this embodiment can be switched in accordance with a change in the meeting status. Switching of the applications can change an application to be displayed on the frontmost screen.

### Automatic Registration of Meeting-Room Terminal

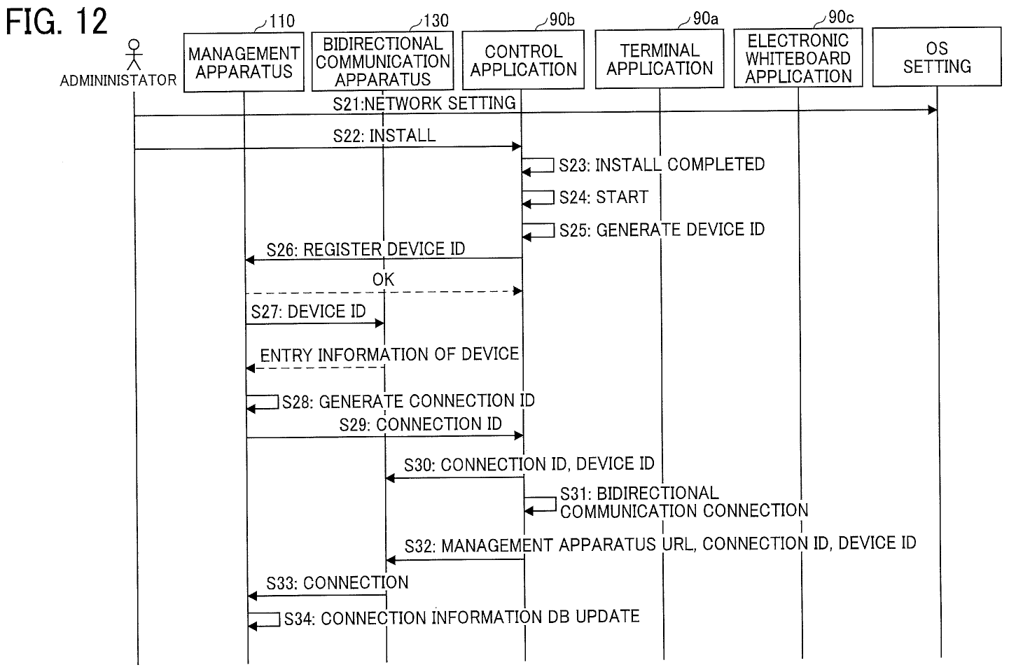

In order that the management apparatus 110 on the cloud communicates with the on-premises meeting-room terminal 90, the meeting-room terminal 90 is expected to be registered in the management apparatus 110 and the bidirectional communication apparatus 130. Thus, first, a procedure of automatic registration of an application of the meeting-room terminal 90 will be described with reference to FIG. 12. FIG. 12 is a sequence diagram example illustrating a procedure in which the control application 90b installed in the meeting-room terminal 90 registers, in the management apparatus 110, an application installed in the meeting-room terminal 90.

S21: First, an administrator operates the OS of the meeting-room terminal 90 and sets network setting. That is, the administrator sets a service set identifier (SSID), a password of the SSID, and the like.

S22: Subsequently, the administrator downloads the control application 90b from an application distribution site and installs the control application 90b in the meeting-room terminal 90. Note that the setting or an installing operation may alternatively be performed by a system user or a terminal owner or administrator. If the control application 90b is already installed, the administrator starts the control application 90b or performs an operation for starting registration.

S23, S24: Installing is completed. The installed control application 90b automatically starts. Alternatively, the administrator may start the control application 90b.

S25: Upon having installed, the device registration unit 82 of the control application 90b starts automatic registration of the meeting-room terminal 90 in the management apparatus 110. In addition, the device registration unit 82 detects installed applications from the OS or the like. The device registration unit 82 generates a unique device ID. The management apparatus 110 may alternatively generate the device ID.

S26: The device registration unit 82 designates the device ID and requests the management apparatus 110 to register the device ID. Upon receiving the device ID, the management apparatus 110 registers the device ID and sends a reply “OK”.

S27: The bidirectional communication unit 111 of the management apparatus 110 transmits the device ID to the bidirectional communication apparatus 130. The bidirectional communication apparatus 130 transmits entry information of a device to the management apparatus 110. The entry information is used for registering the device.

S28: The bidirectional communication unit 111 of the management apparatus 110 receives the entry information, and the registration accepting unit 112 generates a connection ID by using the entry information.

S29: The registration accepting unit 112 of the management apparatus 110 transmits the connection ID to the control application 90b through the bidirectional communication unit 111.

S30: The bidirectional communication unit 81 of the control application 90b receives the connection ID, and the device registration unit 82 transmits the connection ID and the device ID to the bidirectional communication apparatus 130. Note that if the connection ID includes information for identifying the device ID, the device ID is not transmitted. Through this processing, the control application 90b, the management apparatus 110, and the bidirectional communication apparatus 130 can hold the device ID and the connection ID.

S31: Upon completion of registration of the device information, the bidirectional communication unit 81 of the control application 90b starts bidirectional communication (establishes connection) with the management apparatus 110 by using the connection ID.

S32: The bidirectional communication unit 81 of the control application 90b designates the URL of the management apparatus 110, the connection ID, and the device ID and requests the bidirectional communication apparatus 130 to be connected to the management apparatus 110. Subsequently, until force shutdown of the application, for example, the bidirectional communication unit 81 maintains communication between the control application 90b and the bidirectional communication apparatus 130. Note that upon ending the control application 90b, the control application 90b automatically restarts and generates the device ID and obtains the connection ID again.

S33: The bidirectional communication apparatus 130 authenticates the combination of the connection ID and the device ID. If the authentication succeeds, a connection is established to the URL of the management apparatus 110.

S34: The bidirectional communication unit 111 of the management apparatus 110 receives the device ID and updates the connection status associated with the device ID in the connection information DB 122 to “connected”. Thus, the meeting-room terminal 90 and the management apparatus 110 are connected to each other through the bidirectional communication apparatus 130.

While the control application 90b and the bidirectional communication apparatus 130 are connected, the bidirectional communication apparatus 130 performs HTTPS communication by the control application 90b and WebSocket using a specific port (e.g., 443) of the meeting-room terminal 90. Thus, communication can be performed beyond the firewall. Note that the protocol such as HTTPS can be designated by the administrator by using a software development kit (SDK) library within the bidirectional communication apparatus 130.

While the control application 90b and the bidirectional communication apparatus 130 are connected, the control application 90b also operates as a server. Thus, the control application 90b performs setting or control in response to a request from the bidirectional communication apparatus 130.

### Change Degree of Priority

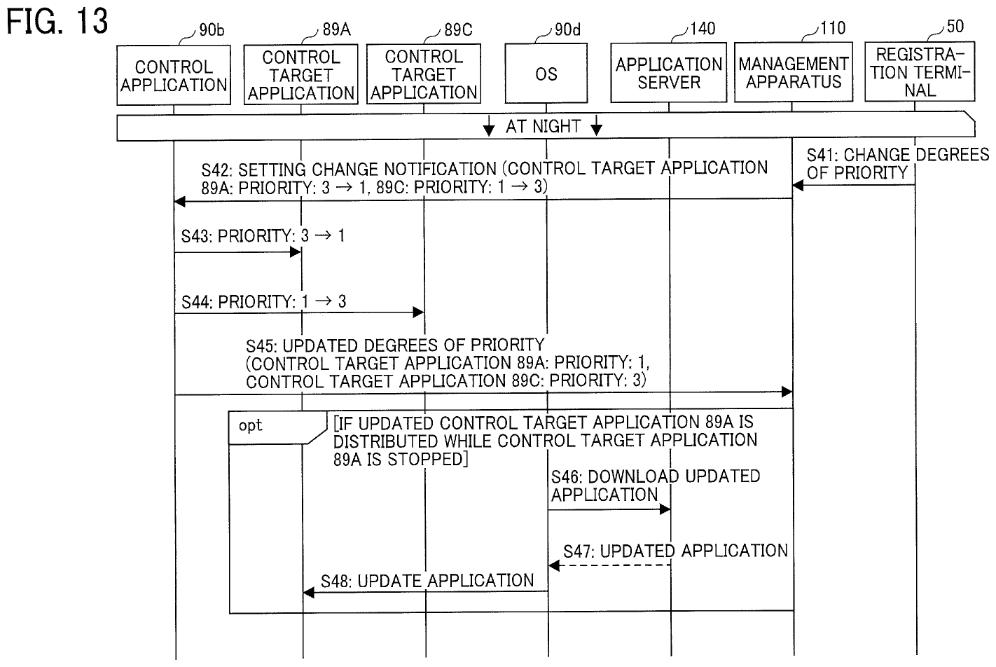

Processing in which the administrator changes the degrees of priority of control target applications 89 will be described with reference to FIG. 13. FIG. 13 is a sequence diagram example illustrating a procedure in which the administrator or the like changes the degrees of priority held by the control application 90b to display a control target application 89 on the frontmost screen.

S41: If the administrator wishes to change the degrees of priority of control target applications 89 (wishes to change the control target application 89 to be displayed on the frontmost screen), the administrator has the registration terminal 50 connected to the management apparatus 110. The management apparatus 110 is a web server that provides a web application and also performs bidirectional communication with the meeting-room terminal 90 through the bidirectional communication apparatus 130. The registration terminal 50 displays a remote setting screen provided by the management apparatus 110, and thus, the administrator can change the degrees of priority of control target applications 89 on the remote setting screen. In addition, the management apparatus 110 can obtain the current degrees of priority of the respective control target applications 89 from the control application 90b. For example, in response to a request from the registration terminal 50, the management apparatus 110 may communicate with the meeting-room terminal 90 to obtain the current degrees of priority of the respective control target applications 89, or may obtain, if a degree of priority is changed, an updated degree of priority of a control target application 89. The administrator can view the degrees of priority of the respective control target applications 89 to determine settings of the degrees of priority of control target applications 89.

Note that although the degrees of priority are changed at night in FIG. 13, the degrees of priority may be changed in daytime.

For the convenience of the description, for example, the current degrees of priority displayed on the registration terminal 50 are as follows:
The control target application 89A: Degree of priority 3
The control target application 89C: Degree of priority 1

In this state, the administrator changes the degree of priority of the control target application 89A to 1 from 3 and the degree of priority of the control target application 89C to 3 from 1.

S42: From the registration terminal 50, the process accepting unit 113 of the management apparatus 110 accepts processing for changing the degree of priority of the control target application 89A to 1 and the degree of priority of the control target application 89C to 3. The bidirectional communication unit 111 of the management apparatus 110 sends a notification of changing the degree of priority of the control target application 89A to 1 and a notification of changing the degree of priority of the control target application 89C to 3 (setting change notification) to the control application 90b of the meeting-room terminal 90 through the bidirectional communication apparatus 130.

S43: The bidirectional communication unit 81 of the control application 90b receives the notification of changing the degree of priority of the control target application 89A to 1 and the notification of changing the degree of priority of the control target application 89C to 3. The in-terminal communication unit 83 of the control application 90b transmits a change request for changing the degree of priority of the control target application 89A to 1.

S44: The in-terminal communication unit 83 of the control application 90b transmits a change request for changing the degree of priority of the control target application 89C to 3.

S45: The bidirectional communication unit 81 of the control application 90b transmits the updated degrees of priority (the degree of priority being 1 for the control target application 89A and the degree of priority being 3 for the control target application 89C) to the management apparatus 110 through the bidirectional communication apparatus 130. Thus, the management apparatus 110 can provide the current degrees of priority to the registration terminal 50.

S46: While a control target application 89 is stopped (i.e., at night), if an updated control target application 89 is distributed from the application server 140, the automatic update unit 86 of the OS performs automatic updating. From the application server 140, the automatic update unit 86 downloads the most-recent-version control target application 89 (updated application).

S47: The application server 140 transmits the most-recent-version control target application 89 to the meeting-room terminal 90.

S48: The automatic update unit 86 receives the most-recent-version control target application 89 and updates the control target application 89. In this manner, since the control application 90b stops each of the control target applications 89 at night, if the most recent version application that is not started is present, the OS can update the application.

### Screen Examples

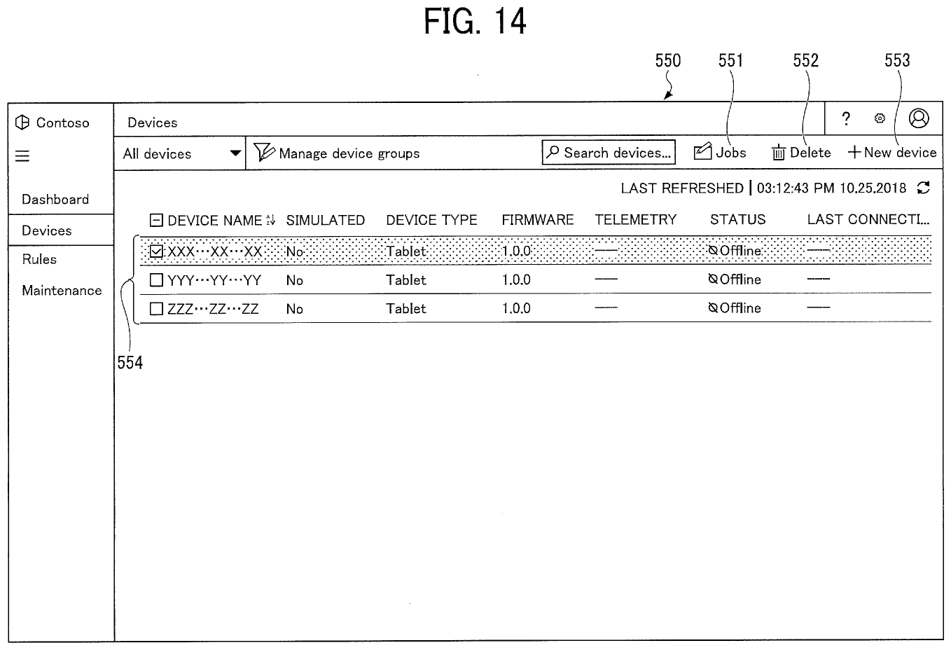

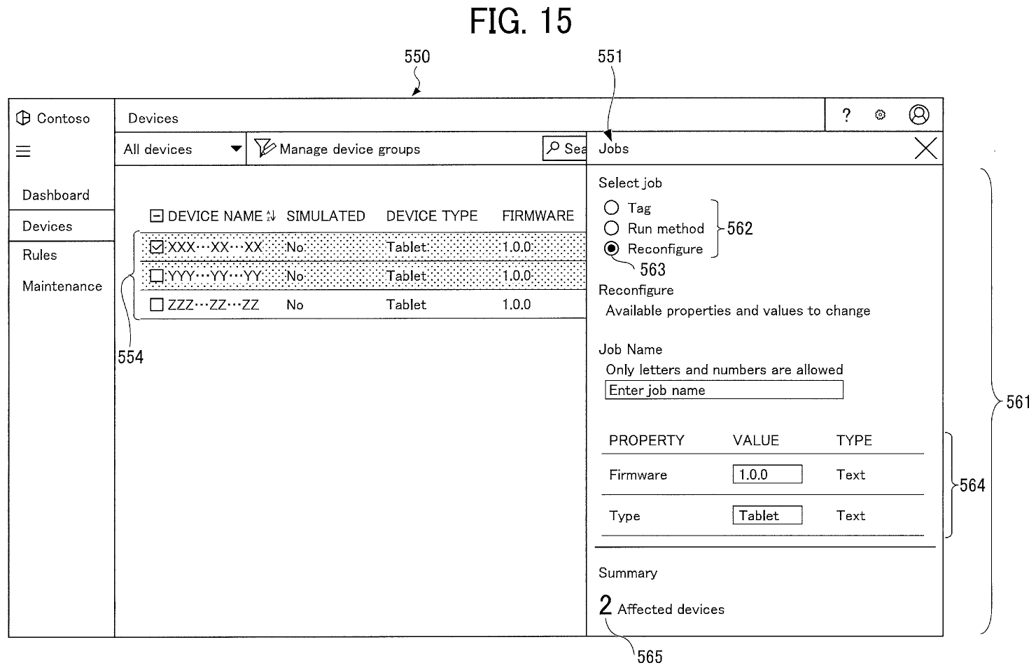

A remote setting screen 550 displayed by the registration terminal 50 in step S41 in FIG. 13 will be described with reference to FIG. 14 and FIG. 15. FIG. 14 illustrates an example of the remote setting screen 550 that displays search results of meeting-room terminals 90. On the remote setting screen 550 in FIG. 15, a list 554 of device names that match a search condition is displayed.

The remote setting screen 550 includes a jobs button 551, a delete button 552, and a new device button 553. The jobs button 551 is used for opening a menu for transmitting setting information to a meeting-room terminal 90. The delete button 552 is used for deleting a meeting-room terminal 90 selected among registered meeting-room terminals 90. The new device button 553 is used for newly registering a meeting-room terminal 90.

FIG. 15 illustrates another example of the remote setting screen 550 that displays, in response to the pressing of the jobs button 551, the menu for transmitting setting information. In a menu 561 in FIG. 15, a radio button 563 is displayed to correspond to each of the jobs in a job type field 562, and “Reconfigure” is selected in FIG. 15. “Reconfigure” means setting change. The menu 561 further includes a setting information accepting field 564 for accepting setting information, and setting information in the setting information accepting field 564 can be transmitted to meeting-room terminals 90. In this embodiment, a degree of priority can be set in the setting information accepting field 564.

The administrator selects from the list 554 of device names, meeting-room terminals 90 to which the setting information is to be transmitted. Thus, a number 565 of meeting-room terminals 90 selected from the list 554 of device names is displayed in the menu 561. If the administrator presses an execution button, the operation accepting unit 52 accepts the pressing, and the communication unit 51 of the registration terminal 50 transmits the setting information in the setting information accepting field 564 to the meeting-room terminals 90 through the management apparatus 110 and the bidirectional communication apparatus 130.

The setting information in the setting information accepting field 564 can be input by the administrator or may be obtained (loaded) from a meeting-room terminal 90. Thus, the administrator can set a meeting-room terminal 90 having the same setting information by a simple operation.

As described above, in the resource reservation system 100 according to this embodiment, if a status of a control target application 89 is changed, the control application 90b detects the change and sends a status-change notification to the control target application 89, and thus, the control target application 89 can change the degree of priority. Since the control application 90b is notified of the degree of priority, the control application 90b can control the control target application 89 to be displayed on the frontmost screen.

### Variations

An embodiment of the present disclosure has been described above. However, the present disclosure is not limited to the embodiment, and various modifications and substitutions may be made without departing from the spirit of the present disclosure.

For example, a control target application operated by a user may change the degree of priority thereof and may send the changed degree of priority to the control application.

In addition, regardless of a user operation, a control target application may change the degree of priority thereof depending on a time slot and may send the changed degree of priority to the control application.

Furthermore, instead of displaying a standby screen or the like on the display 616, the meeting-room terminal 90 may project a screen onto a wall or a screen by using a projector.

In addition, although this embodiment has described the OS called Android as an example, the OS is not limited to Android. For example, iOS (registered trademark) or Windows (registered trademark) may alternatively be used.

Furthermore, although this embodiment has described that the meeting management server 30, the management apparatus 110, and the bidirectional communication apparatus 130 are on the cloud, the meeting management server 30, the management apparatus 110, and the bidirectional communication apparatus 130 may alternatively be provided on-premises.

In addition, a plurality of meeting management servers 30 may be present, and the functions of the meeting management server 30 may be dispersed to a plurality of servers. Furthermore, the reservation management server 20 and the meeting management server 30 may be integrated.

In addition, the resource reservation system 100 according to the embodiment may also be referred to as a web service. The web service is any kind of service provided by applying an Internet-related technique. Examples include a meeting-room lending service and any kind of rental service. A system using the web service is referred to as a use system.

In addition, the configuration examples in FIG. 7, FIG. 8A and FIG. 8B illustrated in the above embodiment are divided in accordance with main functions for easy understanding of the processing of the resource reservation system 100. However, the dividing manner or name of each processing unit does not limit the present disclosure. The resource reservation system 100 may be divided into a larger number of processing units in accordance with a processing content, or a processing unit obtained by dividing may include a larger amount of processing.

The technique in the related art has a drawback in that it is not possible to control the application software to be displayed on the display in accordance with a status of the application software. For example, it is desirable that an information processing terminal that displays meeting reservation information or the like display reservation information before a meeting starts and display, on a display, a screen of application software (e.g., an application for making a record or a whiteboard application) that supports the meeting after the meeting has started. By switching application software to be displayed on the display in accordance with the status of the application software, a single information processing terminal can be used efficiently.

According to one or more embodiments of the present disclosure, an information processing terminal or the like is provided, which can control application software to be displayed on a display in accordance with the status of the application software.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information processing terminal comprising:
a display; and
a memory that stores a plurality of control target applications,
wherein, when a status of a first control target application of the plurality of control target applications is changed, the information processing terminal switches a control target application to be displayed on a frontmost screen of the display in accordance with a change in the status of the first control target application.

2. The information processing terminal of claim 1,
wherein, when the status of the first control target application is changed, the information processing terminal switches the control target application to be displayed on the frontmost screen of the display in accordance with a degree of priority of the control target application, the degree of priority being changed in accordance with the change in the status of the first control target application.

3. The information processing terminal of claim 1,
wherein, when the status of the first control target application is changed, the information processing terminal switches the control target application to be displayed on the frontmost screen of the display to a second control target application whose degree of priority is changed in accordance with the change in the status of the first control target application.

4. The information processing terminal of claim 1,
wherein the information processing terminal is provided in a resource to be reserved by a user,
wherein the first control target application is a standby screen that waits for start of use of the resource by the user, and
wherein, when the first control target application is changed to a use start status in response to the start of use of the resource, the information processing terminal switches the control target application to be displayed on the frontmost screen of the display to a second control target application.

5. The information processing terminal of claim 4,
wherein, when the first control target application is changed to a use end status in response to end of use of the resource, the information processing terminal switches the control target application to be displayed on the frontmost screen of the display to the first control target application.

6. The information processing terminal of claim 4,
wherein the second control target application is an electronic whiteboard application that receives handwritten input.

7. The information processing terminal of claim 3,
wherein the first control target application is an acceptance application that accepts at least operations for checking in and exiting a meeting room,
wherein the second control target application is a meeting application used by a participant of a meeting after the operation for checking in, and
wherein, when the meeting application is displayed on the display, the information processing terminal displays indication of exiting on the frontmost screen of the display.

8. The information processing terminal of claim 7,
wherein the indication of exiting is a button for accepting the operation for exiting.

9. The information processing terminal of claim 7,
wherein the acceptance application displays the indication of exiting closer to a foreground than the meeting application under a predetermined condition in accordance with an end time of reservation of the meeting room, and
wherein the predetermined condition is satisfied when a current time is a predetermined time before the end time of reservation of the meeting room and when the meeting application is displayed closer to the foreground than the acceptance application.

10. A non-transitory recording medium storing a program that causes an information processing terminal to perform processing, the information processing terminal including a display and a memory that stores a plurality of control target applications, the processing comprising:
switching, when a status of a first control target application is changed, a control target application to be displayed on a frontmost screen of the display in accordance with a change in the status of the first control target application.

11. The non-transitory recording medium of claim 10,
wherein the program causes the information processing terminal to function as:
an in-terminal communication unit configured to communicate with the plurality of control target applications; and
an application determination unit configured to determine, when the in-terminal communication unit receives a degree of priority from a second control target application whose degree of priority is changed in accordance with the change in the status of the first control target application, a particular control target application based on the degree of priority received by the in-terminal communication unit,
wherein the in-terminal communication unit notifies the particular control target application determined by the application determination unit that the particular control target application determined by the application determination unit is to be displayed on the frontmost screen.

12. The non-transitory recording medium of claim 11,
wherein when the in-terminal communication unit receives from the first control target application a status-change notification indicating the change in the status, the program causes the information processing terminal to function as a status-change notification sending unit that sends the status-change notification to each second control target application,
wherein the in-terminal communication unit receives from the second control target application, the degree of priority that is changed in accordance with the status-change notification from a degree of priority of the control target application set in advance for the control target application, and
wherein the application determination unit determines the particular control target application based on the degree of priority received by the in-terminal communication unit.

13. A control method performed by an information processing terminal including a display and a memory that stores a plurality of control target applications, the method comprising:
switching, when a status of a first control target application is changed a control target application to be displayed on a frontmost screen of the display in accordance with a change in the status of the first control target application.
